(19) United States
(12) Patent Application Publication
(10) Pub. No.: US 2009/0318663 A1
(43) Pub. Date: Dec. 24, 2009

(54) Polymerizable Spherical Transition Metal Complex, Spherical Transition Metal Complex, and Production Method Thereof

(76) Inventors: Makoto Fujita, Tokyo (JP); Sota Sato, Tokyo (JP); Takashi Murase, Tokyo (JP); Tetsuya Iida, Saitama (JP); Takanobu Higuchi, Saitama (JP); Satoru Tanaka, Saitama (JP)

Correspondence Address: WENDEROTH, LIND & PONACK, L.L.P., 1030 15th Street, N.W.,, Suite 400 East, Washington, DC, 20005-1503, US

(21) Appl. No.: 12/224,831

(22) PCT Filed: Mar. 6, 2007
(86) PCT No.: PCT/JP2007/054313

§ 371 Date: Dec. 31, 2008

(30) Foreign Application Priority Data
Mar. 9, 2006 (JP) 2006-064319
Dec. 26, 2006 (JP) 2006-349235

(51) Int. Cl. C08G 69/26

(52) U.S. Cl. 528/332

(57) ABSTRACT

A polymerizable spherical transition metal complex is provided which has a hollow shell which is formed from transition metal atoms and bidentate organic ligands, the bidentate organic ligands having a substituent having a polymerizable group moiety at an end thereof, and the substituents being oriented towards the interior of the hollow shell. A spherical transition metal complex in which, in the hollow shell of the polymerizable spherical transition metal complex, the polymerizable groups are polymerized, and a production method thereof are also provided. The polymerizable spherical transition metal complex which is a spherical transition metal complex having a hollow shell, is characterized in that the hollow shell is formed from a transition metal atoms (wherein a represents an integer of 6 to 60), and 2a bidentate organic ligands, the bidentate organic ligands have a substituent having at least one or more polymerizable group moieties at an end thereof, and the substituents are oriented towards an interior of the hollow shell. The spherical transition metal complex is characterized in that the polymerizable groups are polymerized in the hollow shell of the polymerizable spherical transition metal complex. The production method thereof is also provided.

### TECHNICAL FIELD

The present invention relates to a polymerizable spherical transition metal complex having a hollow shell which is formed from transition metal atoms and bidentate organic ligands having a substituent having a polymerizable group moiety at an end thereof, in which the substituents of the bidentate organic ligand are oriented towards the interior of the hollow shell. The present invention also relates to a spherical transition metal complex in which, in the hollow shell of the polymerizable spherical transition metal complex, the polymerizable groups are polymerized, and a production method thereof.

### BACKGROUND ART

Strictly-controlled nanosize hollow structures can be divided into three regions: the outer surface; the inner surface; and the isolated interior space. While the outer surface and the interior space have been the subject of a large amount of research, there are hardly any reports of research examples utilizing the inner surface in an artificial system.

Recently, research utilizing the inner surface of nanoscale structures from the natural world, such as spherical proteins like feritin and the spherical virus CCMV, has been carried out. Even if these structures are decomposed by artificial stimulation, they return to their original structure by self-assembled. Functional groups can be precisely arranged on the inner surface of a round shell structure (a spherical structure having a hollow shell) by subjecting the subunits to functional group modification so that they face the inner surface, and re-forming the round shell structure by self-assembled (Non-patent Documents 1 and 2).

The present inventors have also investigated self-assembly utilizing coordinate bonds between organic ligands and transition metal ions. Since coordinate bonds have a suitable bond strength and have a clearly defined direction, a molecular assembly with a precisely-controlled structure can be constructed spontaneously and quantitatively. Furthermore, since the coordination number and bond angle can be controlled according to the kind and oxidation number of the metal, structures having a variety of coordination bonds can be obtained (Non-patent Documents 3 to 5).

For example, in the case of using the planar tetracoordinate Pd(II) ion, the direction of the coordinate bond can be defined as 90 degrees. Especially, various hollow structures self-assemble in their most stable state according to the ligands from a palladium ethylenediamine nitric acid complex [(en)Pd(NO₃)₂] (M) whose cis position is protected by ethylenediamine (en), and panel-shaped organic ligands (L) (Non-patent Documents 6 to 11).

Furthermore, a cubic octahedral type spherical complex having an M₁₂L₂₄ composition formed from many components has also been found to self-assemble (Non-patent Document 12). The obtained complex has a furan or benzene center, 24 bidentate organic ligands which are bent at an angle of about 120 degrees to the center, and 12 Pd(II) ions. These components self-assemble to form a complex formed from a total of 14 surfaces; 8 equilateral triangles and 6 squares. In this case, the number of apexes is 12 and the number of sides is 24, which correspond to the number of metal ions and ligands, respectively.

This structure has been revealed by X-ray crystal structure analysis to have a very large three-dimensional hollow structure with a diameter of approximately 3.5 nm and an interior spatial volume of approximately 22 nm³. Furthermore, it is known that a spherical complex having an M₁₂L₂₄ composition is also similarly constructed from bidentate organic ligands having varied ligand lengths, with a spherical complex 5 nm in diameter being self-assembled. These complexes are spherical, which is the structure with the greatest interior space, and are of a size which can include the protein, nucleic acids etc. of a biomolecule.

For a spherical complex having such an M₁₂L₂₄ composition, it has been revealed that by introducing functional groups onto a certain position of the ligands, 24 functional groups can be precisely arranged all at once on the nanosurface of a spherical capsule by undergoing a self-assembly reaction. For example, a complex in which porphyrin and fullerene are precisely arranged on the surface has been reported (Non-patent Document 12). This complex has promise for applications in biological activities or optical properties utilizing the nanosurface of the spherical structure.

Furthermore, nanosurface-specific functions in which the metamorphism of the protein is markedly increased have been found by introducing a cationic trimethylammonium group so as to construct a cation ball having a 48⁺ charge on the surface (Non-patent Document 13).

Non-patent Document 1: R. M. Kramer, C. Li, D. C. Carter, M. O. Stone, R. R. Naik, J. Am. Chem. Soc., 2004, 126, 13283

Non-patent Document 2: T. Douglas, E. Strable, D. Willits, A. Aitouchen, M. Libera, M. Young, Adv. Mater., 2002, 14, 415

Non-patent Document 3: P. J. Stang, B. Olenyuk, Ace. Chem. Res., 1997, 30, 507

Non-patent Document 4: M. Fujita, Chem. Soc. Rev., 1998, 27, 417

Non-patent Document 5: B. Olenyuk, A. Fechtenkotter, P. J. Stang, J. Chem. Soc. Dalton Trans., 1998, 1707

Non-patent Document 6: M. Fujita, K. Umemoto, M. Yoshizawa, N. Fujita, T. Kusukawa, K. Biradha, Chem. Commun., 2001, 509

Non-patent Document 7: M. Fujita, D. Oguro, M. Miyazawa, H. Oka, K. Yamaguchi, K. Ogura, Nature, 1995, 378, 469

Non-patent Document 8: N. Takeda, K. Umemoto, K. Yamaguchi, M. Fujita, Nature, 1999, 398, 794

Non-patent Document 9: K. Umemoto, H. Tsukui, T. Kusukawa, K. Biradha, M. Fujita, Angew. Chem. Int. Ed., 2001, 40, 2620

Non-patent Document 10: M. Aoyagi, S. Tashiro, M. Tominaga, K. Biradha, M. Fujita, Chem. Commun., 2002, 2036

Non-patent Document 11: T. Yamaguchi, S. Tashiro, M. Tominaga, M. Kawano, T. Ozeki, M. Fujita, J. Am. Chem. Soc., 2004, 10818

Non-patent Document 12: M. Tominaga, K. Suzuki, M. Kawano, T. Kusukawa, T. Ozeki, S. Sakamoto, K. Yamaguchi, M. Fujita, Angew. Chem. Int. Ed., 2004, 43, 5621

Non-patent Document 13: Kenichiro YAGURA, Graduation Thesis, University of Tokyo

### DISCLOSURE OF THE INVENTION

### Problems to be Solved by the Invention

The present invention was created as a part of this kind of research and development by the present inventors. It is an object of the present invention to provide a polymerizable spherical transition metal complex having a hollow shell which is formed from a transition metal atoms (wherein a represents an integer of 6 to 60), and 2a bidentate organic ligands, the bidentate organic ligands having a substituent having at least one or more polymerizable group moieties at an end thereof, and the substituents being oriented towards an interior of the hollow shell; a spherical transition metal complex in which the polymerizable groups in the hollow shell of the above complex are polymerized; and a production method thereof.

### Means for Solving the Problems

The present inventors have succeeded in synthesizing polymerizable spherical transition metal complex which self-assemble with a transition metal compound, using as bidentate organic ligands a synthesized compound in which substituents having a polymerizable group moiety at an end thereof are introduced on the 2 position of 1,3-bis(4-pyridylethynyl)benzene. Furthermore, the present inventors attempted to polymerize the polymerizable groups in the hollow shell by adding a radical polymerization initiator to the obtained complex and heating. As a result, the present inventors discovered that a polymerization reaction proceeds within a limited space, and that a uniform particulate polymer (spherical transition metal complex) can be efficiently obtained, whereby the present invention was completed.

According to a first aspect of the present invention, provided is a polymerizable spherical transition metal complex described in any of the following (1) to (13).

(1) A polymerizable spherical transition metal complex which is a spherical transition metal complex having a hollow shell, characterized in that the hollow shell is formed from a transition metal atoms (wherein a represents an integer of 6 to 60), and 2a bidentate organic ligands, the bidentate organic ligands have a substituent having at least one or more polymerizable group moieties at an end thereof, and the substituents are oriented towards an interior of the hollow shell.
(2) A polymerizable spherical transition metal complex which is a spherical transition metal complex having a hollow shell, characterized in that the hollow shell is formed from b transition metal atoms (wherein b is 6, 12, 24, 30, or 60), and 2b bidentate organic ligands, the bidentate organic ligands have a substituent having at least one or more polymerizable group moieties at an end thereof, and the substituents are oriented towards an interior of the hollow shell.
(3) The polymerizable spherical transition metal complex according to (1), represented by the formula MₐL₂ₐ (wherein a is an integer of 6 to 60, and each M and each L may respectively be the same or different) formed from a transition metal compound (M) and a bidentate organic ligand (L) having the substituent having the at least one or more polymerizable group moieties at the end thereof in a self-assembling manner so that the substituents are oriented towards the interior of the hollow shell.
(4) The polymerizable spherical transition metal complex according to (2), represented by the formula M_{b}L_{2b} (wherein b is 6, 12, 24, 30, or 60, and each M and each L may respectively be the same or different) formed from a transition metal compound (M) and a bidentate organic ligand (L) having the substituent having the at least one or more polymerizable group moieties at the end thereof in a self-assembling manner so that the substituents are oriented towards the interior of the hollow shell.
(5) The polymerizable spherical transition metal complex according to any of (1) to (4), wherein the polymerizable group is a radical polymerizable group.
(6) The polymerizable spherical transition metal complex according to any of (1) to (5), wherein the transition metal atom constituting the transition metal complex is one kind selected from the group consisting of Ti, Fe, Co, Ni, Cu, Zn, Ru, Rh, Pd, Cd, Os, Ir, and Pt.
(7) The polymerizable spherical transition metal complex according to any of (1) to (6), wherein the bidentate organic ligand is a compound represented by the formula (I)

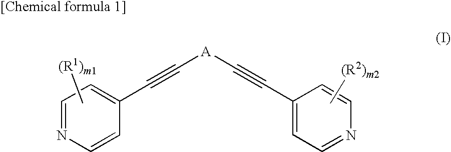

{wherein R¹ and R² each independently represent a halogen atom, an alkyl group which may be substituted, an alkoxyl group which may be substituted, a cyano group, or a nitro group;

m1 and m2 each independently represent an integer of 0 to 4, and when m1 and m2 are 2 or more, each R¹ and each R² may be the same or different;

A represents a group represented by the following formulae (a-1) to (a-4),

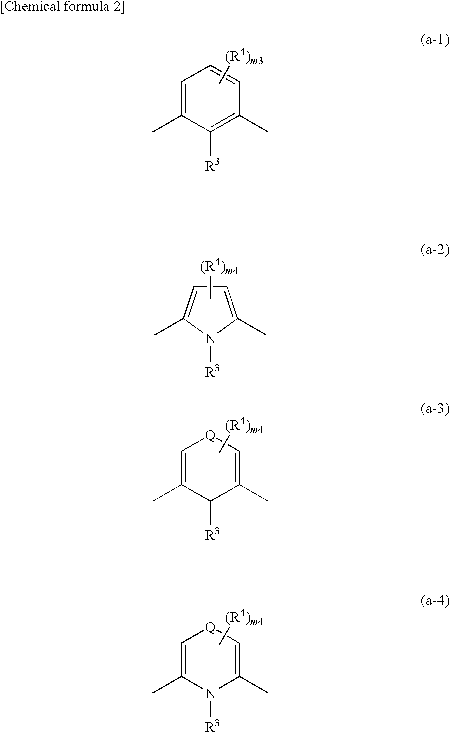

[wherein R³ represents a group having a polymerizable functional group on an end thereof;

R⁴ represents a halogen atom, an alkyl group which may be substituted, an alkoxyl group which may be substituted, a cyano group, or a nitro group;

m3 represents an integer of 0 to 3, m4 represents an integer of 0 to 2, and when m3 is 2 or more and m4 is 2, plural R⁴s may be the same or different; and

Q represents -Nr1- (wherein r1 represents a hydrogen atom, an alkyl group, an aryl group, or an acyl group), —O—, —C(═O), —S—, or —SO₂—]}.

(8) The polymerizable spherical transition metal complex according to (7), wherein R³ is a group represented by the formula -D-E [wherein D represents a linking group represented by the formula —(O—CH₂)s- (wherein s represents an integer of 0 to 20), a linking group represented by the formula —(CH₂)t- (wherein t represents an integer of 0 to 20), or a linking group formed by a combination thereof; and E represents a polymerizable group].
(9) The polymerizable spherical transition metal complex according to (7), wherein R³ has a linking group which has 2 or 3 branches represented by -D1-[wherein D1 is represented by the formula —O—C—, or —O—CH—], and has on each of 2 or 3 branch chains of this linking group a group represented by -D-E [wherein D represents a linking group represented by the formula —(O—CH₂)s- (wherein s represents an integer of 0 to 20), a linking group represented by the formula —(CH₂)t- (wherein t represents an integer of 0 to 20), or a linking group formed by a combination thereof; and E represents a polymerizable group]. Preferably, s and t are each an integer of 10 or less.
(10) The polymerizable spherical transition metal complex according to (8) or (9), wherein s and t of the linking group represented by the above formulae —(O—CH₂)s- and —(CH₂)t- are 3, and if the linking group is formed from a combination of these, the sum of s and t is 3.
(11) The polymerizable spherical transition metal complex according to any of (8) to (10), wherein E is a group represented by the formula —O—CO—C(r2)=CH₂ (wherein r2 represents a hydrogen atom or a methyl group).
(12) The polymerizable spherical transition metal complex according to any of (1) to (6), wherein the bidentate organic ligand is a compound represented by the formula (I-1),

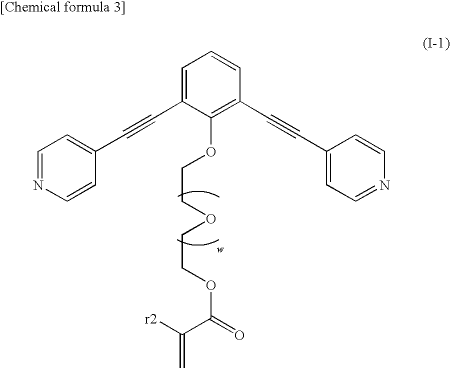

(wherein r2 represents a hydrogen atom or a methyl group; and w represents an integer of 0 to 20, and preferably an integer of 10 or less).
(13) The polymerizable spherical transition metal complex according to any of (1) to (6), wherein the bidentate organic ligand is a compound represented by the formula (I-1′),

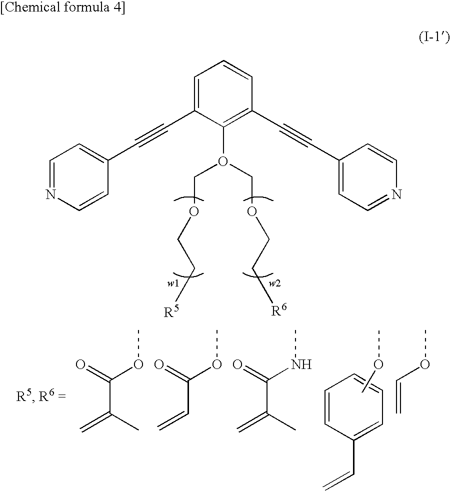

(wherein R⁵ and R⁶ represent a polymerizable group represented by a methacryloxyl group, an acryloxyl group, a methacrylamide group, a vinylphenoxy group, and a vinyloxy group; w1 and w2 represent an integer of 0 to 20, and preferably an integer of 10 or less; R⁵ and R⁶ may be the same or different; and w1 and w2 may be the same or different).

According to a second aspect of the present invention, provided is a method for producing the polymerizable spherical transition metal complex of the present invention described in the following (14).

(14) A method for producing the polymerizable spherical transition metal complex according to any of (1) to (13), characterized by reacting a transition metal compound (M) and a bidentate organic ligand (L) having a substituent having at least one or more polymerizable group moieties at an end thereof, in a proportion of 1 to 5 moles of the bidentate organic ligand (L) with respect to 1 mole of the transition metal compound (M).

According to a third aspect of the present invention, provided is a spherical transition metal complex described in the following (15).

(15) Aspherical transition metal complex obtained by polymerizing the polymerizable spherical transition metal complex according to any of (1) to (13), in which the polymerizable groups are polymerized in the hollow shell to form a polymer.

According to a fourth aspect of the present invention, provided is a method for producing the spherical transition metal complex of the present invention described in the following (16).

(16) A method for producing the spherical transition metal complex according to (15), characterized by adding a polymerization initiator to a solvent solution containing the polymerizable spherical transition metal complex according to any of (1) to (10) to polymerize the polymerizable groups.

### EFFECTS OF THE INVENTION

According to the first aspect of the present invention, a polymerizable spherical transition metal complex is provided in which substituents of bidentate organic ligands, which have the substituent having at least one or more polymerizable group moieties at an end thereof, are concentrated in the interior of the hollow shell of the complex.

According to the second aspect of the present invention, a nanometer scale polymerizable spherical transition metal complex having polymerizable groups in the interior of the spherical structure can be efficiently produced without requiring any complex steps.

According to the third aspect of the present invention, a spherical transition metal complex is provided which is obtained by polymerizing the polymerizable groups of the polymerizable spherical transition metal complex of the present invention.

According to the fourth aspect of the present invention, the spherical transition metal complex of the present invention can be efficiently produced.

If the spherical transition metal complex according to the present invention is decomposed by adding an acid to the complex etc., a nanoparticle polymer having a uniform particle size can be obtained.

### BRIEF DESCRIPTION OF THE DRAWINGS

FIG. 1 is a diagram showing the stereostructure of the polymerizable spherical transition metal complex according to the present invention formed from 12 transition metal compounds (M) and 24 bidentate organic ligands (L) having a substituent having a polymerizable group moiety at an end thereof.

FIG. 2 is a ¹H-NMR spectrum diagram of before and after polymerization when the complex (c) is used.

FIG. 3 is a series of diagrams showing schematic structural models for after polymerization of the complexes (a) to (d).

FIG. 4 is a ¹H-NMR spectrum diagram of the compound (6e) and the complex (e).

FIG. 5 is a ¹H-NMR spectrum diagram of before and after polymerization of the complex (e).

### BEST MODE FOR CARRYING OUT THE INVENTION

The present invention will now be described in more detail by separately describing: 1) a polymerizable spherical transition metal complex; 2) a method for producing the polymerizable spherical transition metal complex; and 3) a spherical transition metal complex and a production method thereof.

### 1) Polymerizable Spherical Transition Metal Complex

The polymerizable spherical transition metal complex according to the present invention is a spherical transition metal complex having a hollow shell, characterized in that the hollow shell is formed from a transition metal atoms (wherein a represents an integer of 6 to 60), and 2a bidentate organic ligands, the bidentate organic ligands have a substituent having at least one or more polymerizable group moieties at an end thereof, and the substituents are oriented towards an interior of the hollow shell.

In the polymerizable spherical transition metal complex according to the present invention, since self-assembly easily progresses, the hollow shell is preferably formed from b transition metal atoms (wherein b is 6, 12, 24, 30 or 60), and 2b bidentate organic ligands. More preferably, b is 6 or 12, and 12 is especially preferable.

The polymerizable spherical transition metal complex according to the present invention is formed by self-assembly utilizing coordinate bonds between transition metal ions and the bidentate organic ligands having a substituent having one or more polymerizable group moieties at an end thereof. Since coordinate bonds have a suitable bond strength and a clearly defined direction, a molecular assembly with a precisely-controlled structure can be constructed spontaneously and quantitatively. Furthermore, since the coordination number and bond angle can be controlled according to the kind and oxidation number of the transition metal, the structure may have a variety of coordination bonds.

The polymerizable spherical transition metal complex according to the present invention is preferably represented by the formula MₐL₂ₐ (wherein a has the same meaning as described above), and is formed in a self-assembling manner from a transition metal compound (M) and a bidentate organic ligand (L) having a substituent having one or more polymerizable group moieties at an end thereof (hereinafter, sometimes simply referred to as “bidentate organic ligand (L)”), wherein the substituents are oriented towards the interior of the shell. More preferably, the inventive polymerizable spherical transition metal complex is represented by the formula M_{b}L_{2b} (wherein b has the same meaning as described above), and is formed in a self-assembling manner from the transition metal compound (M) and the bidentate organic ligand (L), wherein the substituents are oriented towards the interior of the shell. Here, while each M and each L may be the same or different, they are preferably the same.

The size of the hollow shell of the polymerizable spherical transition metal complex according to the present invention is not especially limited, but the diameter thereof is preferably 3 to 15 nm.

The transition metal atom constituting the polymerizable spherical transition metal complex according to the present invention is not especially limited, but is preferably one kind selected from the group consisting of Ti, Fe, Co, Ni, Cu, Zn, Ru, Rh, Pd, Cd, Os, Ir, and Pt. Since a planar tetracoordinate complex can be easily formed, platinum group atoms such as Ru, Rh, Pd, Os, Ir and Pt are preferred, Ru, Pd, and Pt are more preferred, and Pd is especially preferred.

The valence of the transition metal atom is usually 0 to 4, and preferably is 2. The coordination number is usually 4 to 6, and preferably is 4.

The bidentate organic ligand (L) which forms the polymerizable spherical transition metal complex according to the present invention is not especially limited, as long as it has a substituent having one or more polymerizable group moieties at an end thereof, and can form the polymerizable spherical transition metal complex in a self-assembling manner with the transition metal atoms so that the substituents are oriented towards the interior of the shell. However, a compound represented by the following formula (I) is preferred.

Compounds represented by the formula (I) have an acetylene group as a bridge moiety adjacent to pyridyl groups, and while maintaining planarity, have a structure with a wide space between the pyridyl groups at either end.

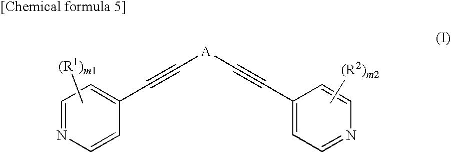

In the formula, R¹ and R² each independently represent a halogen atom, an alkyl group which may be substituted, an alkoxyl group which may be substituted, a cyano group, or a nitro group.

m1 and m2 each independently represent an integer of 0 to 4, and when m1 and m2 are 2 or more, each R¹ and each R² may be the same or different.

A represents one compound represented by the following formulae (a-1) to (a-4).

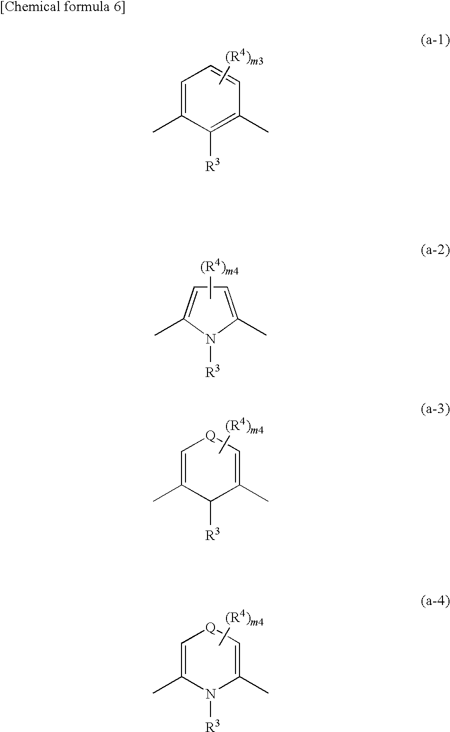

In the formula, R³ represents a group having a polymerizable group moiety at an end thereof, and is preferably a group represented by the formula -D-E. In this formula, D is a linking group represented by the formula -(O—CH₂)s-, a linking group represented by the formula —(CH₂)t-, or a linking group formed by a combination thereof. In the formula, s and t each independently represent an integer of 0 to 20, and preferably an integer of 10 or less.

Furthermore, as another example, R³ preferably has a linking group which has 2 or 3 branches represented by -D1-[wherein D1 is represented by —O—C—, or —O—CH—], and has on each of the 2 or 3 branch chains of this linking group a group represented by -D-E. D and E have the same meanings as described above. Thus, by having a linking group which has 2 or 3 branches, the bidentate organic ligand (L) can be constituted having 2 or 3 polymerizable group moieties at an end thereof. These 2 or 3 polymerizable group moieties may be the same or different. By thus having a plurality of polymerizable group moieties on a single bidentate organic ligand (L), there are the advantages that the functions can be improved, and greater functionality can be achieved by selecting a combination of polymerizable group moieties having different functions.

E represents a polymerizable group. The polymerizable group is not especially limited, so long as it polymerizes in the hollow shell of the complex. Examples thereof include an anionic polymerizable group, a cationic polymerizable group, a radical polymerizable group and the like. Referring to the below-described test results, to ensure a high polymerization rate, s and t in the linking group represented by the above-described formulae -(O—CH₂)s- and —(CH₂)t- are 3. If the linking group is formed from a combination of these, the sum of s and t is more preferably 3.

Among these examples, E is preferably a radical polymerizable group. More preferably, E is a group represented by the formula —O—CO—C(r2)=CH₂ (wherein r2 represents a hydrogen atom or a methyl group), a group represented by the formula —C(r3)=CH₂ (wherein r3 represents a hydrogen atom, a methyl group, a nitrile group, or a halogen atom), a group represented by the formula —N(r4)-CO—C(r2)=CH₂ (wherein r2 has the same meaning as described above, and r4 represents a hydrogen atom, or an alkyl group such as a methyl group, an ethyl group, or an isopropyl group), a group represented by the formula —CO—O—C(r2)=CH₂ (wherein r2 has the same meaning as described above), a p-vinylbenzoyl group, or a p-vinylbenzoyloxy group. This is due to the fact that the groups are more concentrated in the center of the polymerizable spherical transition metal complex, so that the polymerization reaction proceeds easily. Especially preferred is a group represented by the formula —O—CO—C(r2)=CH₂.

In the formula, R⁴ represents a halogen atom, an alkyl group which may be substituted, an alkoxyl group which may be substituted, a cyano group, or a nitro group.

m3 represents an integer of 0 to 3, m4 represents an integer of 0 to 2, and when m3 is 2 or more and m4 is 2, plural R^{4s} may be the same or different.

Examples of the R¹, R², and R⁴ halogen atom include a fluorine atom, a chlorine atom, a bromine atom and the like.

Examples of the R¹, R², and R⁴ alkyl group which may be substituted include alkyl groups having 1 to 20 carbon atoms, such as a methyl group, an ethyl group, an isopropyl group, an n-butyl group, a t-butyl group, an n-pentyl group, an n-hexyl group, an n-octyl group, an n-nonyl group, and an n-decyl group.

Furthermore, examples of the substituent of the R¹, R², and R⁴ alkyl group which may be substituted include a halogen atom, an alkoxyl group, a phenyl group which may have a substituent and the like.

Examples of the alkoxyl group of the R¹, R², and R⁴ alkoxyl group which may be substituted include an alkoxyl group having 1 to 20 carbon atoms, such as a methoxy group, an ethoxy group, a propoxy group, an isopropoxy group, a butoxy group, a t-butoxy group, a pentyloxy group, and a hexyloxy group. Furthermore, examples of the substituent of the R¹, R², and R⁴ alkoxyl group which may be substituted include a halogen atom, a phenyl group which may have a substituent and the like.

Q represents -Nr1- (wherein r1 represents a hydrogen atom, an alkyl group, an aryl group, or an acyl group), —O—, —C(═O), —S—, or —SO₂—.

Examples of r1 alkyl groups include a methyl group, ethyl group and the like. Examples of r1 aryl groups include a phenyl group, a p-methylphenyl group and the like. Examples of r1 acyl groups include an acetyl group, a benzoyl group and the like.

As the bidentate organic ligand (L) used in the present invention, a compound represented by the following formula (I-1) is especially preferred.

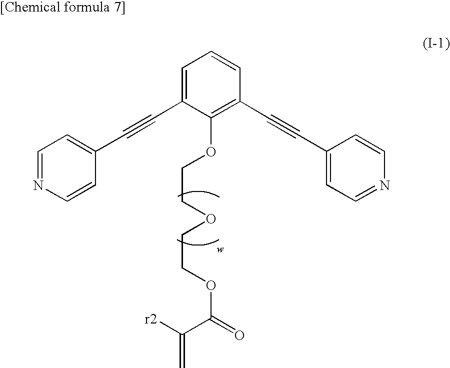

In the formula, r2 represents a hydrogen atom or a methyl group, and w represents an integer of 0 to 20, preferably an integer of 10 or less, and preferably an integer of 1 to 4.

Furthermore, as another example of the bidentate organic ligand (L) used in the present invention, a compound represented by the following formula (I-1′) is especially preferred.

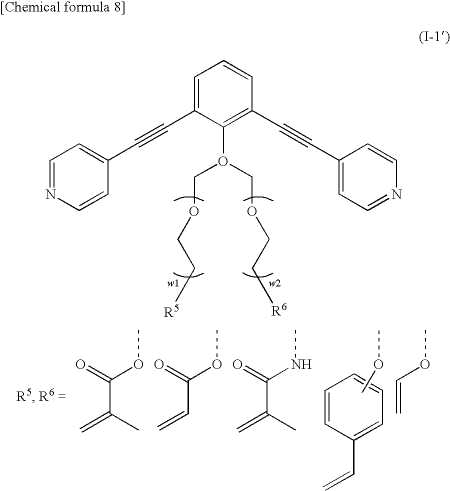

In the formula, R⁵ and R⁶ represent a polymerizable group represented by a methacryloxyl group, an acryloxyl group, a methacrylamide group, a vinylphenoxy group, and a vinyloxy group; w1 and w2 represent an integer of 0 to 20, preferably an integer of 10 or less, and more preferably an integer of 1 to 4; R⁵ and R⁶ may be the same or different; and w1 and w2 may be the same or different.

The bidentate organic ligand (L) may be produced by using a well known synthesis method.

For example, among the compounds represented by the above formula (I), a compound represented by the following formula (I-2) can be produced as described below according to a well-known documented method (K. Sonogashira, Y. Tohda, N. Hagihara, Tetrahedron Lett., 1975, 4467; J. F. Nguefack, V. Bolitt, D. Sinou, Tetrahedron Lett., 1996, 31, 5527).

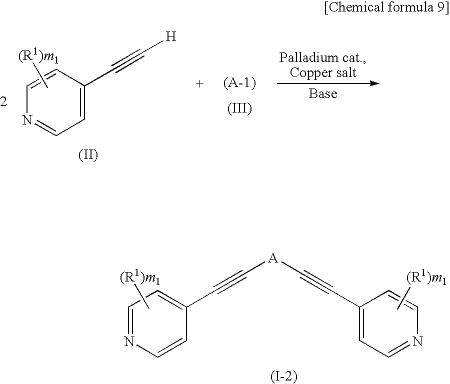

In the formula, A, R¹, and m1 have the same meanings as described above.

(A-1) represents a compound represented by the formula X-A-X.

X represents a halogen atom such as a chlorine atom, a bromine atom, and a iodine atom.

Specifically, a compound represented by the formula (I-2) can be obtained by reacting a 4-ethynylpyridine (or salt thereof) represented by the formula (II) and a compound (A-1) represented by the formula (III) in a suitable solvent in the presence of a base, a palladium catalyst such as Pd(PhCN)₂Cl₂/P(t-Bu)₃ and Pd(PPh₃)₄, and a copper salt such as copper(I) iodide.

The above reaction is an example of producing a compound having two of the same pyridinylethynyl groups by reacting two 4-ethynylpyridines (or salts thereof) in one go. A compound having different substituted pyridylethynyl groups can be obtained by reacting the corresponding 4-ethynylpyridines (or salts thereof) in stages under the similar conditions.

Examples of the base used here include amines such as dimethylamine, diethylamine, diisopropylamine, triethylamine, and diisopropylethylamine.

Examples of the used solvent include ethers such as 1,4-dioxane, isopropylether, tetrahydrofuran (THF), 1,3-dimethoxyethane; amides such as dimethylformamide; sulfoxides such as dimethylsulfoxide; nitrites such as acetonitrile; and the like.

The reaction temperature, usually, is in the temperature range of from 0° C. to the boiling point of the solvent, and is preferably from 10 to 70° C. The reaction time depends on the scale of the reaction and the like, but is usually from several minutes to several tens hours.

Although the 4-ethynylpyridines (or salts thereof) may be produced by a well-known method, commercially available products may also be used as is.

Furthermore, the compound represented by the formula (III) may be produced by a well-known method. For example, from the compound (A-1) used in the production of the compound represented by from the formula (I-2) can be synthesized by the following production methods 1 to 3.

### (Production Method 1)

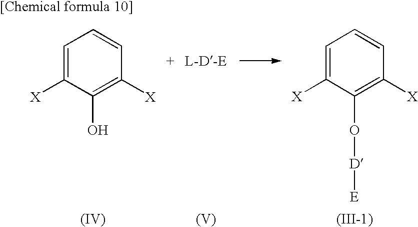

(Wherein E and X have the same meanings as described above, the group O-D′ corresponds to D, and L represents a leaving group.)

Specifically, the compound represented by the formula (III-1) can be obtained by reacting a compound represented by the formula (IV) and a compound represented by the formula (V) in the presence of a base.

Examples of the used base include inorganic salts such as sodium bicarbonate, sodium carbonate, potassium carbonate, sodium hydroxide, sodium hydride; amines such as triethylamine, pyridine, 1,8-diazabicyclor5.4.0]-7-undecene (DBU); metal alkoxides such as potassium t-butoxide, sodium methoxide; and the like.

This reaction is preferably carried out in a solvent. The used solvent is not especially limited as long as it is inert in the reaction. Examples of the solvents include ethers such as diethyl ether, THF, and 1,4-dioxane; aromatic hydrocarbons such as benzene, toluene, and xylene; halogenated hydrocarbons such as dichloromethane, chloroform, and 1,2-dichloroethane; nitriles such as acetonitrile; amides such as dimethylformamide (DMF); sulfoxides such as dimethylsulfoxide (DMSO); aromatic amines such as pyridine; and the like.

This reaction proceeds smoothly in the temperature range of from −15° C. to the boiling point of the used solvent. The reaction time depends on the scale of the reaction and the like, but is from several minutes to 50 hours.

### (Production Method 2)

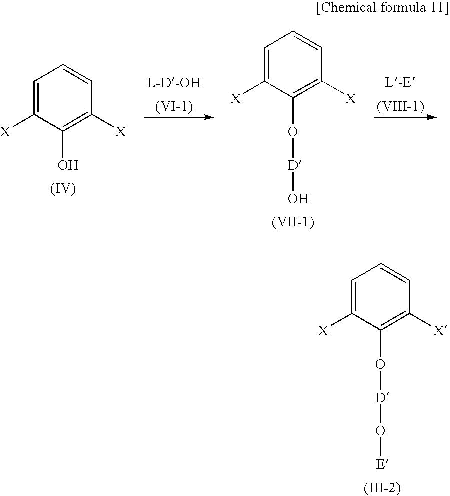

(wherein D′, L, and X have the same meanings as described above, L′ represents a leaving group, and the group O-E′ corresponds to E.)

Furthermore, a compound represented by the formula (III-2) can be obtained by reacting a compound represented by the formula (IV) and a compound represented by the formula (VI-1) in the presence of a base to obtain a compound represented by the formula (VII-1), then reacting this compound with a compound represented by the formula (VIII) in the presence of a base.

The reaction for obtaining the compound represented by the formula (VII-1) can be carried out in the same manner as in Production Method 1.

In the reaction for obtaining the compound represented by the formula (III-2), examples of the used base and the used solvent include the same ones as given for Production Method 1.

This reaction proceeds smoothly in the temperature range of from −15° C. to the boiling point of the used solvent, and preferably in the temperature range of from 0° C. to 50° C. The reaction time depends on the scale of the reaction and the like, but is from several minutes to 24 hours.

### (Production Method 3)

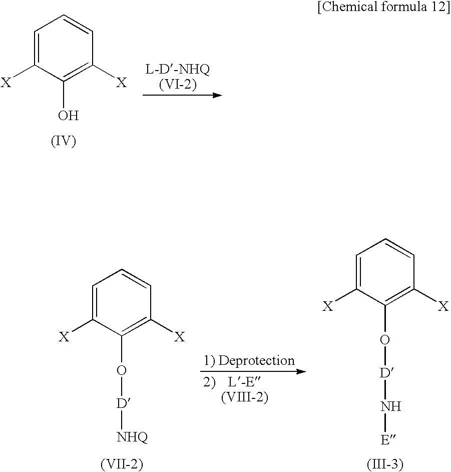

(wherein D′, L, L′, and X have the same meanings as described above, the group NH-E″ corresponds to E, and Q represents a protecting group of an amino group such as a t-butoxycarbonyl group)

Furthermore, a compound represented by the formula (III-3) can be obtained by reacting a compound represented by the formula (IV) and a compound represented by the formula (VI-2) in the presence of a base to obtain a compound represented by the formula (VII-2), deprotecting the protecting group of the amino group, and then reacting the resultant compound with a compound represented by the formula (VIII-2) in the presence of a base.

The reaction for obtaining the compound represented by the formula (VII-2) can be carried out in the same manner as in Production Method 1.

In the reaction for obtaining the compound represented by the formula (III-3), examples of the used base and the used solvent include the same ones as given for Production Method 1.

This reaction proceeds smoothly in the temperature range of from −15° C. to the boiling point of the used solvent, and preferably in the temperature range of from 0° C. to 50° C. The reaction time depends on the scale of the reaction and the like, but is from several minutes to 24 hours.

### (Production Method 4)

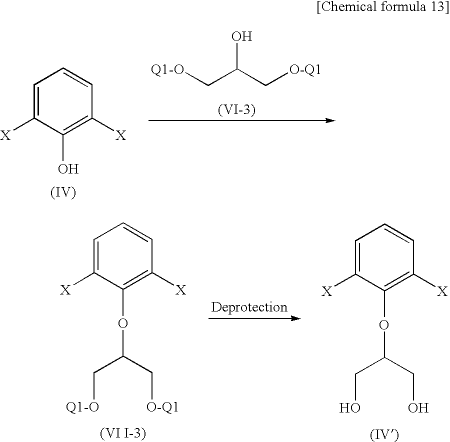

To produce the bidentate organic ligand (L) having two polymerizable group moieties represented in the above formula (I-1′), a compound represented by the formula (IV′) is produced. In order, first the —OHs at the first and third positions of glycerin are protected by the protecting group Q1, such as a tetrabutylammonium group, to produce a compound represented by the formula (VI-3). This compound is reacted with a compound represented by the formula (IV) in the presence of a base to produce a compound represented by the formula (VII-3), and this compound is deprotected to produce a compound represented by the formula (IV′). The —OHs of the thus-obtained compound represented by the formula (IV′) are substituted with polymerizable groups according to the method described in Production Method 1, to thereby produce the bidentate organic ligand (L) represented in the formula (I-1′).

In any of the reactions, the target product may be isolated by, after the reaction has finished, carrying out typical post-treatment and drying operations and optionally a well-known purification operation.

The structure of the obtained compound can be identified and confirmed by measuring the IR, NMR, and MS spectra and the like.

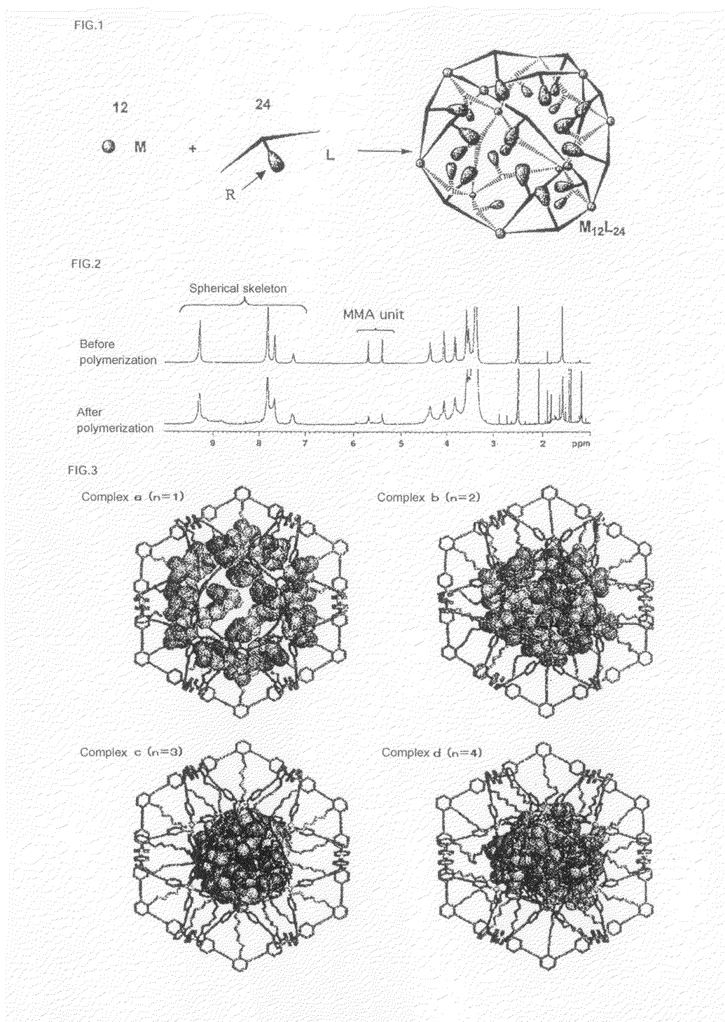

FIG. 1 shows one example of the polymerizable spherical transition metal complex according to the present invention. The polymerizable spherical transition metal complex shown in FIG. 1 is formed from 12 transition metal compounds (M) and 24 bidentate organic ligands (L).

The polymerizable spherical transition metal complex shown in FIG. 1 is constructed by the self-assembly of 12 metal ions and 24 bent bidentate organic ligands (L), and has a wide space in its interior. Furthermore, the bidentate organic ligands (L) each have a substituent R having a polymerizable group moiety on an end thereof. The substituents R are precisely arranged on the inner surface of the spherical shell.

### 2) Method for Producing the Polymerizable Spherical Transition Metal Complex

The method for producing the polymerizable spherical transition metal complex according to the present invention is characterized by reacting a transition metal compound (M) and a bidentate organic ligand (L) in a proportion of 1 to 5 moles of the bidentate organic ligand (L), and preferably 2 to 3 moles of the bidentate organic ligand (L), with respect to 1 mole of the transition metal compound (M).

Although the transition metal compound (M) used in the present invention is not especially limited as long as it can form a polymerizable spherical transition metal complex with the bidentate organic ligand (L) in a self-assembling manner, a divalent transition metal compound is preferred.

Examples of the transition metal atoms constituting the transition metal compounds (M) include transition metal atoms such as Ti, Fe, Co, Ni, Cu, Zn, Ru, Rh, Pd, Cd, Os, Ir, or Pt. Among these, since a planar tetracoordinate complex can be easily formed, platinum group atoms such as Ru, Rh, Pd, Os, Ir and Pt are preferred, Ru, Pd, and Pt are more preferred, and Pd is especially preferred.

Specific examples of the transition metal compounds (M) include halides, nitrates, hydrochlorides, sulfates, acetates, methanesulfonates, trifluoromethanesulfonates, p-toluenesulfonates and the like of a transition metal. Among these, nitrates or trifluoromethanesulfonates of a transition metal are preferred, as the target polymerizable spherical transition metal complex can be efficiently obtained.

The used proportion between the transition metal compound (M) and the bidentate organic ligand (L) may be appropriately set according to the composition of the target polymerizable spherical transition metal complex and the like. For example, if it is desired to obtain a transition metal complex having the above-described M₁₂L₂₄ composition, the bidentate organic ligand (L) may be reacted in a proportion of 2 to 3 moles with respect to 1 mole of the transition metal compound (M).

The reaction between the transition metal compound (M) and the bidentate organic ligand (L) can be carried out in a suitable solvent.

Examples of the used solvent include nitriles such as acetonitrile; sulfoxides such as dimethylsulfoxide (DMSO); amides such as N,N-dimethylformamide; ethers such as diethyl ether, tetrahydrofuran, 1,2-dimethoxyethane, and 1,4-dioxane; halogenated hydrocarbons such as dichloromethane and chloroform; aliphatic hydrocarbons such as pentane and hexane; aromatic hydrocarbons such as benzene and toluene; alcohols such as methanol, ethanol, and isopropyl alcohol; ketones such as acetone and methyl ethyl ketone; cellosolves such as ethyl cellosolve; water; and the like. These solvents may be used alone or in combination of two or more thereof.

The reaction between the transition metal compound (M) and the bidentate organic ligand (L) proceeds smoothly in the temperature range of from 0° C. to the boiling point of the used solvent.

The reaction time is from several minutes to several days.

The target polymerizable spherical transition metal complex may be isolated by, after the reaction has finished, carrying out typical post-treatments, such as column purification by filtration, ion-exchange resin or the like, distillation, and recrystallization.

The counter ions of the obtained polymerizable spherical transition metal complex are usually the anions of the used transition metal compound (M). However, to improve crystallinity or improve the stability of the polymerizable spherical transition metal complex, the counter ions may be exchanged. Examples of such counterions include PF₆⁻, ClO₄⁻, SbF₄⁻, AsF₆⁻, BF₄⁻, SiF₆²⁻ and the like.

The structure of the obtained polymerizable spherical transition metal complex can be confirmed by well-known analytical means, such as ¹H-NMR, ¹³C-NMR, IR spectrum, mass spectrum, visible light absorption spectrum, UV absorption spectrum, reflection spectrum, X-ray crystal structure analysis, and elemental analysis.

Thus, the polymerizable spherical transition metal complex according to the present invention can be efficiently produced in this manner by a very simple operation. As a result, large-scale synthesis in the scale of grams is also possible.

The polymerizable spherical transition metal complex according to the present invention has a nanometer scale fixed size, and a particular structure which is precisely controlled in which the substituents R of the bidentate organic ligand (L) having a polymerizable group moiety on an end are oriented towards the interior of the complex spherical structure. Thus, since the polymerizable groups of the bidentate organic ligand (L) can be concentrated in the interior of the hollow shell of the complex, as is described below, a nanometer scale, uniform particulate polymer can be easily produced by polymerizing these polymerizable groups.

### 3) Spherical Transition Metal Complex and Production Method Thereof

The spherical transition metal complex according to the present invention is a spherical transition metal complex in which the polymerizable groups of the bidentate organic ligands of the polymerizable spherical transition metal complex according to the present invention are polymerized in the interior of the hollow shell.

Examples of a method for producing the spherical transition metal complex include: (1) a method including reacting a transition metal compound (M) and a bidentate organic ligand (L) in a proportion of 1 to 5 moles of the bidentate organic ligand (L) with respect to 1 mole of the transition metal compound (M), and then adding a polymerization initiator to the reaction system to polymerize the polymerizable groups in the hollow shell; and (2) a method including dissolving the polymerizable spherical transition metal complex according to the present invention in a suitable solvent, and then adding a polymerization initiator to the resultant solution to polymerize the polymerizable groups in the hollow shell.

In the method (1), the reaction between the transition metal compound (M) and the bidentate organic ligand (L) may be carried out under the same conditions as in the method for producing the polymerizable spherical transition metal complex according to the present invention.

Examples of the solvent used in the method (2) include the same solvents given as examples of solvents to be used in the reaction between the transition metal compound (M) and the bidentate organic ligand (L).

In both the methods (1) and (2), if the polymerizable groups are anionic polymerizable groups an anionic polymerization initiator is used, if the polymerizable groups are cationic polymerizable groups a cationic polymerization initiator is used, and if the polymerizable groups are radical polymerizable groups a radical polymerization initiator is used. Among these, in the present invention it is preferred that the polymerizable groups are radical polymerizable groups, and that the polymerization reaction is carried out using a radical polymerization initiator, for reasons such as the polymerization reaction can be carried out under neutral conditions.

Examples of the used anionic polymerization initiator include alkali metals such as lithium and sodium; and organoalkali metals such as organolithium compounds, organosodium compounds, and organopotassium compounds; and the like.

Examples of the cationic polymerization initiator include iodonium salts, sulfonium salts, Lewis acids and the like.

The radical polymerization initiator is not especially limited as long as it is a compound which decomposes to generate free radicals. Examples thereof include azo compounds such as 2,2′-azobisisobutyronitrile (AIBN); organoperoxides such as benzoyl peroxide; and the like.

These polymerization initiators can be used in the range of usually 0.5 to 20 moles, and preferably 1 to 10 moles, with respect to 1 mole of the polymerizable spherical transition metal complex.

Prior to carrying out the polymerization reaction, it is preferred to remove oxygen and the like in the reaction solution. To remove oxygen and the like in the reaction solution, for example, freeze-thaw cycles can be used.

Specifically, first, the reaction solution in the whole reaction vessel is frozen, the pressure inside the vessel is reduced, and the vessel is sealed under reduced pressure. Next, the reaction vessel is heated to dissolve the reaction solution. Once oxygen present in the solution has escaped from the reaction solution, the interior of the reaction vessel is returned to ordinary temperature by argon gas. By repeating this operation, oxygen and the like can be removed from the reaction solution.

The polymerization reaction can be carried out while optionally irradiating with light in a range of, usually, from −50° C. to the reflux temperature of the used solvent.

The reaction time depends on the scale of the reaction and the like, but is usually from several minutes to 50 hours.

The polymerization reaction can be terminated by adding a polymerization terminator to the reaction solution or by lowering the temperature of the reaction solution.

Confirmation of whether the polymerization reaction has finished can be carried out by gas chromatography, liquid chromatography, NMR and the like. For example, in the case of polymerizing a polymerizable spherical transition metal complex produced using a compound represented by the formula (I-1) (wherein r2 is methyl) for the bidentate organic ligand (L), a decrease in the signal corresponding to the methacrylic units is confirmed by measuring the ¹H-NMR spectrum of the polymerized complex. The polymerization conversion rate can be calculated by quantifying the integral values of this signal before and after polymerization.

The target spherical transition metal complex according to the present invention may be isolated by, after the reaction has finished, carrying out typical post-treatments for organic synthetic chemistry, and optionally purifying by well-known separation and purification means such as column purification, purification under reduced pressure, and filtration.

If the thus-obtained spherical transition metal complex is decomposed, a polymer having nanoparticles with a uniform particle size can be obtained. Examples of a method for decomposing the complex include adding an acid to the complex.

A similar known reaction method is micellar polymerization, in which polymerization is carried out in the interior of a micelle. However, by using the polymerizable spherical transition metal complex according to the present invention, polymer nanoparticles having much better uniformity than that for micellar polymerization can be obtained.

### EXAMPLES

Next, the present invention will be described in more detail by way of examples. However, the present invention is in no way limited by the examples.

### (Instruments)

### (1) Measurement of the ¹H-NMR Spectrum

The ¹H-NMR spectrum was measured using a Bruker DRX 500 (500 MHz) NMR spectrometer and a JEOL JNM-AL 300 (300 MHz) NMR spectrometer.

Furthermore, the chemical shift was displayed as a 5 value with the following abbreviations: s (singlet signal), d (doublet signal), t (triplet signal), and br (broad).

### (2) Measurement of the ¹³C-NMR Spectrum and Various Two-dimensional NMR Spectra

The ¹³C-NMR spectrum and various two-dimensional NMR spectra were measured using a Bruker DRX 500 (125 MHz) NMR spectrometer.

### (3) Measurement of the Mass Spectrum

GC-MS was measured using an Agilent 5973 inert.

Electrospray ionization mass spectrometry (ESI-MS) was measured using a Waters ZQ-2000M.

Cold spray ionization mass spectrometry (CSI-MS) was measured using a JEOL JMS-700C.

### (Reagents)

As the reaction solvents, anhydrous solvents for organic synthesis (water content of 0.005% or less) commercially available from Wako Pure Chemical Industries Ltd., and Kanto Chemical Co., Ltd., were used as is.

As the reagents, commercially available products were used as is without particularly purifying.

Complexes (a) to (d) were produced in the following manner.

The production route is illustrated by the following reaction formulae.

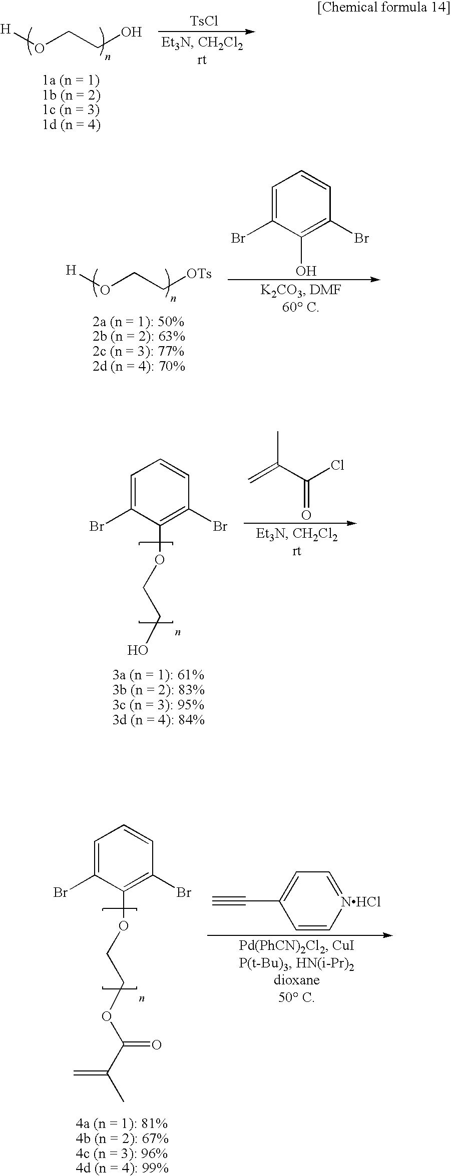

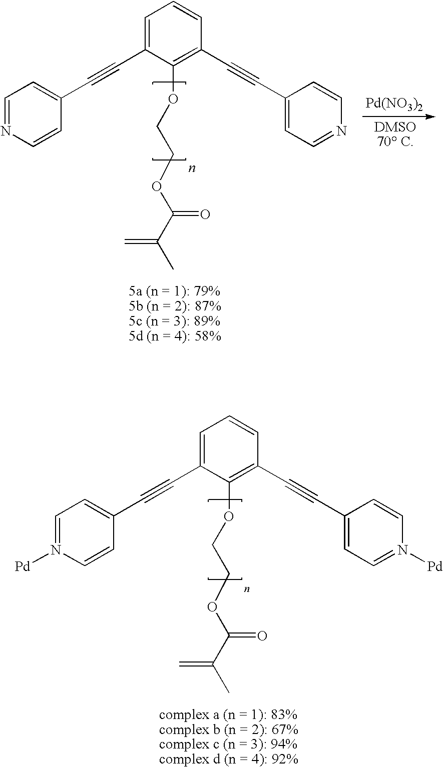

### (1) Synthesis of Compounds (2a) to (2d)

Monotosyl oligoethylene glycol (2a) was produced according to the method described in Tetrahedron, 1987, 4271, and (2b) to (2d) were produced according to the method described in Org. Bimol. Chem., 2003, 2661.

### (2-a) Synthesis of Compound (3a)

3.05 g (14.1 mmol) of the compound (2a) and 2,6-dibromophenol were dissolved in 100 mL of DMF. The resultant mixture was charged with 3.88 g (28.0 mmol) of potassium carbonate, and the reaction mixture was stirred for 35 hours at 60° C. This reaction solution was concentrated, and then charged with chloroform. The organic layer was successively washed with 1 M potassium hydrogensulfate, water, and saturated brine. The organic layer was dried with anhydrous sodium sulfate, and then filtered. The filtrate was concentrated under reduced pressure, and the obtained concentrated product was purified by silica gel column chromatography (chloroform) to give 2.01 g (6.80 mmol) of the compound (3a) (yield 61%).

### (Physical Property Values)

Colorless Oil

¹H-NMR (500 MHz, CDCl₃, δ ppm); 7.52 (d, J=8.0 Hz, 2H), 6.98 (t, J=8.0 Hz, 1H), 4.21 4.20 (m, 2H), 4.01 3.98 (m, 2H), 2.45 (br t, 1H)

¹³C-NMR (125 MHz, CDCl₃, δ ppm); 152.8 (C), 132.9 (CH), 126.5 (CH), 118.3 (C), 74.8 (CH₂), 62.1 (CH₂)

GC-MS (EI); m/z=296 (M⁺)

Anal. Calcd for C₈H₈Br₂O₂: C, 32.47; H, 2.72, Found: C, 32.35; H, 2.78

### (2-b) Synthesis of Compound (3b)

Using 2.88 g (11.1 mmol) of the compound (2b) and 2.32 g (9.22 mmol) of 2,6-dibromophenol, 2.62 g (7.69 mmol) of the compound (3b) was obtained in the same manner as the synthesis of compound (3a) (yield 83%).

### (Physical Property Values)

Colorless Oil

¹H-NMR (500 MHz, CDCl₃, δ ppm); 7.51 (d, J=8.0 Hz, 2H), 6.87 (t, J=8.0 Hz, 1H), 4.23 4.21 (m, 2H), 3.96-3.94 (m, 2H), 3.79-3.78 (m, 2H), 3.73-3.71 (m, 2H), 2.24 (br t, 1H)

¹³C-NMR (125 MHz, CDCl₃, δ ppm); 153.2 (C), 132.8 (CH), 126.4 (CH), 118.4 (C), 72.5 (CH₂), 72.4 (CH₂), 70.1 (CH₂), 61.9 (CH₂)

ESI-MS; m/z: 362.9 [M+Na]⁺, 340.9 [M+H]⁺

Anal. Calcd for C₁₀H₁₂Br₂O₃: C, 35.32; H, 3.56, Found: C, 35.16; H, 3.57

### (2-c) Synthesis of Compound (3c)

Using 2.22 g (7.30 mmol) of the compound (2c) and 1.53 g (6.09 mmol) of 2,6-dibromophenol, 2.21 g (5.75 mmol) of the compound (3c) was obtained in the same manner as the synthesis of compound (3a) (yield 94%).

### (Physical Property Values)

Colorless Oil

¹H-NMR (500 MHz, CDCl₃, δ ppm); 7.50 (d, J=8.0 Hz, 2H), 6.86 (d, J=8.0 Hz, 1H), 4.22-4.20 (m, 2H), 3.96-3.94 (m, 2H), 3.81-3.78 (m, 2H), 3.76-3.72 (m, 4H), 3.65-3.63 (m, 2H), 2.37 (br t, 1H)

¹³C-NMR (125 MHz, CDCl₃, δ ppm); 153.3 (C), 132.8 (CH), 126.4 (CH), 118.4 (C), 72.5 (CH₂), 72.4 (CH₂), 70.9 (CH₂), 70.5 (CH₂), 70.2 (CH₂), 61.9 (CH₂)

ESI-MS; m/z: 406.9 [M+Na]⁺, 384.9 [M+H]⁺

Anal. Calcd for C₁₂H₁₆Br₂O₄: C, 37.53; H, 4.20, Found: C, 37.25; H, 4.16

### (2-d) Synthesis of Compound (3d)

Using 3.38 g (9.69 mmol) of the compound (2d) and 1.91 g (7.34 mmol) of 2,6-dibromophenol, 2.62 g (6.13 mmol) of the compound (3d) was obtained in the same manner as the synthesis of the compound (3a) (yield 84%).

### (Physical Property Values)

Colorless Oil

¹H-NMR (500 MHz, CDCl₃, δ ppm); 7.50 (d, J=8.0 Hz, 2H), 6.86 (d, J=8.0 Hz, 1H), 4.21-4.19 (m, 2H), 3.95-3.93 (m, 2H), 3.80-3.78 (m, 2H), 3.74-3.69 (m, 8H), 3.62-3.61 (m, 2H), 2.71 (br t, 1H)

¹³C-NMR (125 MHz, CDCl₃, δ ppm); 153.3 (C), 132.7 (CH), 126.3 (CH), 118.4 (C), 72.5 (CH₂), 72.4 (CH₂), 70.8 (CH₂), 70.71 (CH₂), 70.65 (CH₂), 70.4 (CH₂), 70.1 (CH₂), 61.8 (CH₂)

ESI-MS; m/z: 451.0 [M+Na]⁺, 429.0 [M+H]⁺

Anal. Calcd for C₁₄H₂₀Br₂O₅: C, 39.28; H, 4.71, Found: C, 39.00; H, 4.75

### (3-a) Synthesis of Compound (4a)

0.80 mL (8.19 mmol) of methacryloyl chloride was added dropwise under an argon atmosphere to a solution of 1.21 g (4.09 mmol) of the obtained compound (3a), 1.3 mL (9.33 mmol) of triethylamine, and 2.0 mg (16.1 μmol) of p-methoxyphenol (used as a radical inhibitor) in dry 1,2-dichloromethane. The reaction mixture was stirred for 9 hours at room temperature. The reaction mixture was charged with water, and the resultant mixture was then successively washed with water and saturated brine. The mixture was dried with anhydrous sodium sulfate, and then filtered. The filtrate was concentrated under reduced pressure, and the obtained concentrated product was purified by silica gel column chromatography (chloroform/hexane=1:2 (v/v)) to give 1.21 g (3.30 mmol) of the compound (4a) (yield 81%).

### (Physical Property Values)

Colorless Oil

¹H-NMR (500 MHz, CDCl₃, δ ppm): 7.51 (d, J=8.0 Hz, 2H), 6.88 (d, J=8.0 Hz, 1H), 6.18 (s, 1H), 5.60 (t, J=1.5 Hz, 1H), 4.57-4.56 (m, 2H), 4.31-4.29 (m, 2H), 1.98 (s, 3H)

¹³C-NMR (125 MHz, CDCl₃, δ ppm); 167.3 (C), 152.8 (C), 136.1 (C), 132.8 (CH), 126.5 (CH), 126.1 (CH₂), 118.4 (C), 70.8 (CH₂), 63.6 (CH₂), 18.3 (CH₃)

ESI-MS; m/z: 364.9 [M+H]⁺

Anal. Calcd for C₁₂H₁₂Br₂O₃: C, 39.59; H, 3.32, Found: C, 39.75; H, 3.45

### (3-b) Synthesis of Compound (4b)

Using 2.02 g (5.95 mmol) of the obtained compound (3b), 1.1 mL (11.3 mmol) of methacryloyl chloride, and 1.7 mL (12.2 mmol) of triethylamine, 1.63 g (4.00 mmol) of the compound (4b) was obtained in the same manner as the synthesis of compound (4a) (yield 67%).

### (Physical Property Values)

Pale Yellow Oil

¹H-NMR (500 MHz, CDCl₃, δ ppm); 7.50 (d, J=8.0 Hz, 2H), 6.86 (t, J=8.0 Hz, 1H), 6.15 (s, 1H), 5.58 (t, J=1.5 Hz, 1H), 4.36-4.34 (m, 2H), 4.21-4.19 (m, 2H), 3.96-3.94 (m, 2H), 3.89-3.87 (m, 2H), 1.96 (s, 3H)

¹³C-NMR (125 MHz, CDCl₃, δ ppm): 167.4 (C), 153.3 (C), 136.2 (C), 132.8 (CH), 126.3 (CH), 125.8 (CH₂), 118.4 (C), 72.5 (CH₂), 70.2 (CH₂), 69.3 (CH₂), 64.0 (CH₂), 18.4 (CH₃)

ESI-MS: m/z: 430.6 [M+Na]⁺, 408.7 [M+H]⁺

Anal. Calcd for C₁₄H₁₆Br₂O₄: C, 41.20; H, 3.95, Found: C, 41.22; H, 4.01

### (3-c) Synthesis of Compound (4c)

Using 2.55 g (6.64 mmol) of the obtained compound (3c), 1.3 mL (13.3 mmol) of methacryloyl chloride, and 2.0 mL (14.3 mmol) of triethylamine, 2.87 g (6.35 mmol) of the compound (4c) was obtained in the same manner as the synthesis of the compound (4a) (yield 96%).

### (Physical Property Values)

Pale Yellow Oil

¹H-NMR (500 MHz, CDCl₃, δ ppm); 7.50 (d, J=8.0 Hz, 2H), 6.86 (t, J=8.0 Hz, 1H), 6.14 (s, 1H), 5.57 (t, J=1.5 Hz, 1H), 4.32-4.30 (m, 2H), 4.21-4.19 (m, 2H), 3.95-3.93 (m, 2H), 3.79-3.77 (m, 4H), 3.72-3.71 (m, 2H), 1.95 (s, 3H)

¹³C-NMR (125 MHz, CDCl₃, δ ppm); 167.4 (C), 153.3 (C), 136.2 (C), 132.8 (CH), 126.3 (CH), 125.7 (CH₂), 118.4 (C), 72.4 (CH₂), 70.9 (CH₂), 70.8 (CH₂), 70.2 (CH₂), 69.3 (CH₂), 63.9 (CH₂), 18.3 (CH₃)

ESI-MS: m/z: 474.9 [M+Na]⁺, 452.9 [M+H]⁺

Anal. Calcd for C₁₆H₂₀Br₂O₅: C, 42.50; H, 4.46, Found: C, 42.39: H, 4.29

### (3-d) Synthesis of Compound (4d)

Using 1.92 g (4.48 mmol) of the obtained compound (3d), 0.9 mL (9.21 mmol) of methacryloyl chloride, and 1.4 mL (10.0 mmol) of triethylamine, 2.87 g (6.35 mmol) of the compound (4d) was obtained in the same manner as the synthesis of compound (4a) (yield 96%).

### (Physical Property Values)

Pale Yellow Oil

¹H-NMR (500 MHz, CDCl₃, δ ppm); 7.50 (d, J=8.1 Hz, 2H), 6.86 (t, J=8.1 Hz, 1H), 6.13 (s, 1H), 5.57 (t, J=1.5 Hz, 1H), 4.31-4.29 (m, 2H), 4.21-4.19 (m, 2H), 3.94-3.92 (m, 2H), 3.79-3.74 (m, 4H), 3.71-3.68 (m, 6H), 1.95 (s, 3H)

¹³C-NMR (125 MHz, CDCl₃, δ ppm); 167.4 (C), 153.3 (C), 136.2 (C), 132.7 (CH), 126.3 (CH), 125.7 (CH₂), 118.4 (C), 72.4 (CH₂), 70.9 (CH₂), 70.8 (CH₂), 70.7 (2CH₂), 70.1 (CH₂), 69.2 (CH₂), 63.9 (CH₂), 18.3 (CH₃)

ESI-MS: m/z: 497.2 [M+Na]⁺

Anal. Calcd for C₁₈H₂₄Br₂O₆: C, 43.57: H, 4.88, Found: C, 43.57; H, 4.88

### (4-a) Synthesis of Compound (5a)

0.62 mL (0.21 mmol; 10% hexane solution) of tri-t-butylphosphine and 2.0 mL (14 mmol) of diisopropylamine were charged into a solution of 628 mg (1.72 mmol) of the obtained compound (4a), 724 mg (5.19 mmol) of 4-ethynylpyridine hydrochloride, 39.5 mg (0.103 mmol) of Pd(PhCN)₂Cl₂, 13.8 mg (0.0725 mmol) of copper(I) iodide (CuI), and 2.5 mg (0.020 mmol) of p-methoxyphenol (used as a radical inhibitor) in 3 mL of deaerated dioxane.

The resultant mixture was stirred for 22 hours at 50° C. under an argon atmosphere. The reaction solution was charged with chloroform (15 mL), and then filtered. The filtrate was successively washed with aqueous ethylenediamine and saturated brine. The mixture was dried with anhydrous sodium sulfate, and then filtered. The filtrate was concentrated under reduced pressure, and the obtained concentrated product was purified by silica gel column chromatography (chloroform/methanol=100:1 (v/v)) to give the compound (5a) in a yield of 79%.

### (Physical Property Values)

Yellow Oil.

¹H-NMR (500 MHz, CDCl₃, δ ppm): 8.63 (br s, 4H), 7.55 (d, J=7.8 Hz, 2H), 7.39 (d, J=5.7 Hz, 4H), 7.13 (d, J=7.8 Hz, 1H), 5.97 (s, 1H), 5.43 (t, J=1.5 Hz, 1H), 4.64-4.62 (m, 2H), 4.59-4.56 (m, 2H), 1.81 (s, 3H)

¹³C-NMR (125 MHz, CDCl₃, δ ppm); 167.2 (C), 161.3 (C), 149.9 (CH), 135.9 (C), 134.7 (CH), 131.0 (C), 126.0 (CH₂), 125.5 (CH), 124.0 (CH), 116.8 (C), 91.5 (C), 89.3 (C), 72.2 (CH₂), 64.3 (CH₂), 18.1 (CH₃)

ESI-MS; m/z: 409.1 [M+H]⁺

Anal. Calcd for C₂₆H₂₀N₂O₃.0.25H₂O: C, 75.62; H, 5.00; N, 6.78, Found: C, 75.49; H, 5.30; N, 6.57

### (4-b) Synthesis of Compound (5b)

Using 99.1 mg (0.243 mmol) of the compound (4b), 104 mg (0.742 mmol) of 4-ethynylpyridine hydrochloride, 6.2 mg (0.016 mmol) of Pd(PhCN)₂Cl₂, 3.0 mg (0.016 mmol) of CuI, 0.10 mL (0.034 mmol; 10% hexane solution) of tri-t-butylphosphine, and 0.50 mL (3.6 mmol) of diisopropylamine, 95.4 mg (0.211 mmol) of the compound (5b) was obtained in the same manner as the synthesis of the compound (5a) (yield 87%).

### (Physical Property Values)

Pale Orange Oil.

¹H-NMR (500 MHz, CDCl₃, δ ppm): 8.62 (d, J=6.0 Hz, 4H), 7.54 (d, J=7.7 Hz, 2H), 7.40 (d, J=6.0 Hz, 4H), 7.13 (t, J=7.7 Hz, 1H), 6.08 (s, 1H), 5.53 (t, J=1.6 Hz, 1H), 4.50-4.48 (m, 2H), 4.28-4.26 (m, 2H), 3.96-3.94 (m, 2H), 3.82-3.80 (m, 2H), 1.91 (s, 3H)

¹³C-NMR (125 MHz, CDCl₃, δ ppm); 167.3 (C), 161.5 (C), 149.9 (CH), 136.1 (C), 134.6 (CH), 131.2 (C), 125.8 (CH₂), 125.4 (CH), 123.9 (CH), 116.9 (C), 91.4 (C), 89.5 (C), 73.7 (CH₂), 70.7 (CH₂), 69.5 (CHs), 63.8 (CH₂), 18.3 (CH₃)

ESI-MS; m/z: 452.9 [M+H]⁺

Anal. Calcd for C₂₈H₂₄N₂O₄.0.60H₂O: C, 72.59; H, 5.48: N, 6.05, Found: C, 72.87; H, 5.51; N, 5.66

### (4-c) Synthesis of Compound (5c)

Using 1.09 mg (2.41 mmol) of the compound (4c), 965 mg (6.91 mmol) of 4-ethynylpyridine hydrochloride, 56.8 mg (0.148 mmol) of Pd(PhCN)₂Cl₂, 19.7 mg (0.103 mmol) of CuI, 0.90 mL (0.30 mmol; 10% hexane solution) of tri-t-butylphosphine, and 3.0 mL (21 mmol) of diisopropylamine, 1.07 mg (2.15 mmol) of the compound (5c) was obtained in the same manner as the synthesis of the compound (5a) (yield 89%).

### (Physical Property Values)

Yellow Oil

¹H-NMR (500 MHz, CDCl₃, δ ppm); 8.62 (d, J=6.0 Hz, 4H), 7.54 (d, J=7.8 Hz, 2H), 7.41 (d, J=6.0 Hz, 4H), 7.12 (t, J=7.8 Hz, 1H), 6.09 (s, 1H), 5.53 (t, J=1.5 Hz, 1H), 4.51-4.49 (m, 2H), 4.26-4.23 (m, 2H), 3.95-3.93 (m, 2H), 3.72-3.71 (m, 2H), 3.68-3.66 (m, 2H), 3.62-3.60 (m, 2H), 1.92 (s, 3H)

₁₃C-NMR (125 MHz, CDCl₃, δ ppm); 167.3 (C), 161.6 (C), 149.9 (CH), 136.2 (C), 134.6 (CH), 131.2 (C), 125.7 (CH₂), 125.5 (CH), 123.8 (CH), 116.9 (C), 91.4 (C), 89.6 (C), 73.7 (CH₂), 70.9 (CH₂), 70.8 (CH₂), 70.6 (CH₂), 69.2 (CH₂), 63.8 (CH₂), 18.3 (CH₃)

ESI-MS; m/z: 497.2 [M+H]⁺

Anal. Calcd for C₃₀H₂₈N₂O₅: C, 72.56: H, 5.68; N, 5.64, Found: C, 71.18; H, 5.67; N, 5.37

### (4-d) Synthesis of Compound (5d)

Using 1.10 mg (2.23 mmol) of the compound (4d), 934 mg (6.69 mmol) of 4-ethynylpyridine hydrochloride, 52.8 mg (0.138 mmol) of Pd(PhCN)₂Cl₂, 17.8 mg (0.0935 mmol) of CuI, 0.85 mL (0.29 mmol; 10% hexane solution) of tri-t-butylphosphine, and 3.0 mL (21 mmol) of diisopropylamine, 0.704 mg (1.30 mmol) of the compound (5d) was obtained in the same manner as the synthesis of the compound (5a) (yield 58%).

### (Physical Property Values)

Yellow Oil

¹H-NMR (500 MHz, CDCl₃, δ ppm); 8.63 (d, J=5.7 Hz, 4H), 7.54 (d, J=7.8 Hz, 2H), 7.42 (d, J=5.7 Hz, 4H), 7.12 (t, J=7.8 Hz, 1H), 6.11 (s, 1H), 5.54 (t, J=1.6 Hz, 1H), 4.50-4.48 (m, 2H), 4.28-4.25 (m, 2H), 3.95-3.93 (m, 2H), 3.73-3.69 (m, 4H), 3.62-3.56 (m, 6H), 1.93 (s, 3H)

¹³C-NMR (125 MHz, CDCl₃, δ ppm): 167.3 (C), 161.6 (C), 149.9 (CH), 136.2 (C), 134.6 (CH), 131.2 (C), 125.7 (CH₂), 125.5 (CH), 123.8 (CH), 116.9 (C), 91.4 (C), 89.6 (C), 73.7 (CH₂), 70.9 (CH₂), 70.7 (CH₂), 70.6 (3CH₂), 69.2 (CH₂), 63.8 (CH₂), 18.3 (CH₃)

ESI-MS; m/z: 541.2 [M+H]⁺, 563.2 [M+Na]⁺

Anal. Calcd for C₃₂H₃₂N₂O₆.0.75H₂O: C, 69.36; H, 6.09; N, 5.06, Found: C, 69.49; H, 6.36; N, 4.95

(5-a) Synthesis of Complex (a) 5.75 mg (14.1 μmol) of the obtained compound (5a) was charged into a solution of 1.64 mg (7.1 μmol) of Pd(NO₃)₂ in DMSO (0.7 mL), and the resultant mixture was stirred for 4 hours at 70° C. When the reaction solution was charged with a mixed solvent of ethyl acetate and diethyl ether (volume ratio 1:1), the target complex (a) precipitated as an ocher solid. The structure of the complex (a) was confirmed by ¹H-NMR. The isolated yield was 83% (6.10 g).

### (Physical Property Values)

¹H-NMR (DMSO-d₆, 500 MHz, 27° C., δ ppm); 9.28 (br s, 96H), 7.83 (br s, 96H), 7.69 (br d, J=7.2 Hz, 48H), 7.26 (br t, J=7.2 Hz, 48H) 5.60 (br s, 24H), 5.34 (br s, 24H), 4.67 (br s, 48H), 4.44 (br s, 48H), 1.46 (br s, 72H)

¹³C-NMR (125 MHz, DMSO-d₆, 27° C., δ ppm); 166.2 (C), 162.3 (C), 151.0 (CH), 136.1 (CH), 135.3 (C), 134.1 (C), 128.5 (CH), 125.7 (CH₂), 124.5 (CH), 114.8 (C), 93.8 (C), 90.0 (C), 72.8 (CH₂), 64.6 (CH₂), 17.4 (CH₃)

CSI-MS was carried out by charging CF₃SO₃Na into a solution of the complex (a) in DMSO, and then measuring after the counter anions had been converted into CF₃SO₃⁻.

CSI-MS (CF₃SO₃⁻ salt, CH₃CN); m/z: 2294.1 [M-6 (CF₃SO₃⁻)]⁶⁺, 1945.4 [M-7 (CF₃SO₃⁻)]⁷⁺, 1683.1 [M-8 (CF₃SO₃⁻)]⁸⁺, 1479.3 [M-9 (CF₃SO₃⁻)]⁹⁺, 1316.6 [M-10 (CF₃SO₃⁻)]¹⁺, 1183.3 [M-11 (CF₃SO₃⁻)]¹¹⁺, 1072.0 [M-12 (CF₃SO₃⁻)]¹²⁺, 978.1 [M-13 (CF₃SO₃)]¹³⁺, 897.5 [M-14 (CF₃SO₃⁻)]¹⁴⁺

### (5-b) Synthesis of Complex (b)

6.38 mg (14.1 μmol) of the obtained compound (5b) was charged into a solution of 1.65 mg (7.2 μmol) of Pd(NO₃)₂ in DMSO (0.7 mL), and the resultant mixture was stirred for 4 hours at 70° C. When the reaction solution was charged with a mixed solvent of ethyl acetate and diethyl ether (volume ratio 1:1), the target complex (b) precipitated as an ocher solid. The structure of the complex (b) was confirmed by ¹H-NMR. The isolated yield was 67% (5.40 g)

### (Physical Property Values)

¹H-NMR (DMSO-d₆, 500 MHz, 27° C., δ ppm); 9.27 (br s, 96H), 7.82 (br s, 96H), 7.68 (br d, J=7.1 Hz, 48H), 7.26 (br s, 24H), 5.76 (br s, 24H), 5.42 (br t, J=1.4 Hz, 24H), 4.41 (br s, 48H), 4.14 (br s, 48H), 3.86 (br s, 48H), 3.70 (br s, 48H), 1.62 (br s, 72H)

¹³C-NMR (125 MHz, DMSO-d₆, 27° C., δ ppm); 166.3 (C), 162.2 (C), 151.1 (CH), 136.1 (CH), 135.5 (C), 134.3 (C), 128.4 (CH), 125.6 (CH₂), 124.6 (CH), 115.1 (C), 93.9 (C), 89.9 (C), 74.0 (CH₂), 70.1 (CH₂), 68.4 (CH₂), 63.6 (CH₂), 17.7 (CH₃) CSI-MS was carried out by charging CF₃SO₃Na into a solution of the complex (b) in DMSO, and then measuring after the counter anions had been converted into CF₃SO₃⁻.

CSI-MS (CF₃SO₃⁻ salt, CH₃CN): m/z: 2993.9 [M-5 (CF₃SO₃⁻)]⁵⁺, 2469.6 [M-6 (CF₃SO₃⁻)]⁶⁺, 2095.8 [M-7 (CF₃SO₃⁻)]⁷⁺, 1815.3 [M-8 (CF₃SO₃⁻)]⁸⁺, 1596.7 [M-9 (CF₃SO₃⁻)]⁹⁺, 1422.3 [M-10 (CF₃SO₃⁻)]¹⁰⁺, 1279.3 [M-11 (CF₃SO₃⁻)]¹¹⁺, 1160.3 [M-12 (CF₃SO₃⁻)]¹²⁺, 1059.4 [M-13 (CF₃SO₃⁻)]¹³⁺, 973.1 [M-14 (CF₃SO₃⁻)]¹⁴⁺, 898.3 [M-15 (CF₃SO₃⁻)]¹⁵⁺

### (5-c) Synthesis of Complex (c)

6.96 mg (14.0 μmol) of the obtained compound (5c) was charged into a solution of 1.64 mg (7.1 μmol) of Pd(NO₃)₂ in DMSO (0.7 mL), and the resultant mixture was stirred for 4 hours at 70° C. When the reaction solution was charged with a mixed solvent of ethyl acetate and diethyl ether (volume ratio 1:1), the target complex (c) precipitated as an ocher solid. The structure of the complex (c) was confirmed by ¹H-NMR. The isolated yield was 94% (8.10 g)

### (Physical Property Values)

¹H-NMR (DMSO-d₆, 500 MHz, 27° C., δ ppm); 9.30 (br s, 96H), 7.83 (br s, 96H), 7.67 (br d, J=6.7 Hz, 48H), 7.26 (br s, 24H), 5.70 (br s, 24H), 5.41 (brs, 24H), 4.37 (brs, 48H), 4.07 (brs, 48H), 3.83 (br s, 48H), 3.59 (br s, 96H), 3.54 (br s, 48H), 1.61 (br s, 72H)

¹³C-NMR (125 MHz, DMSO-d₆, 27° C., δ ppm); 166.1 (C), 162.2 (C), 151.0 (CH), 136.0 (CH), 135.4 (C), 134.2 (C), 128.4 (CH), 125.4 (CH₂), 124.6 (CH), 115.1 (C), 93.8 (C), 89.8 (C), 73.9 (CH₂), 70.0 (CH₂), 69.72 (CH₂), 69.68 (CH₂), 68.1 (CH₂), 63.4 (CH₂), 17.6 (CH₃)

CSI-MS was carried out by charging CF₃SO₃Na into a solution of the complex (c) in DMSO, and then measuring after the counter anions had been converted into CF₃SO₃⁻.

CSI-MS (CF₃SO₃⁻ salt, CH₃CN); m/z; 2246.3 [M-7 (CF₃SO₃⁻)]⁷⁺, 1947.6 [M-8 (CF₃SO₃⁻)]⁸⁺, 1714.0 [M-9 (CF₃SO₃⁻)]⁹⁺, 1527.6 [M-10 (CF₃SO₃⁻)]¹⁺, 1375.1 [M-11 (CF₃SO₃⁻)]¹¹⁺, 1248.1 [M-12 (CF₃SO₃⁻)]¹²⁺, 1140.6 [M-13 (CF₃SO₃⁻)]¹³⁺, 1048.7 [M-14 (CF₃SO₃⁻)]¹⁴⁺

### (5-d) Synthesis of Complex (d)

7.56 mg (14.0 μmol) of the obtained compound (5d) was charged into a solution of 1.64 mg (7.1 μmol) of Pd(NO₃)₂ in DMSO (0.7 mL), and the resultant mixture was stirred for 4 hours at 70° C. When the reaction solution was charged with a mixed solvent of ethyl acetate and diethyl ether (volume ratio 1:1), the target complex (d) precipitated as an ocher solid. The structure of the complex (d) was confirmed by ¹H-NMR. The isolated yield was 92% (8.39 g).

### (Physical Property Values)

¹H-NMR (DMSO-d₆, 500 MHz, 27° C., δ ppm); 9.29 (br s, 96H), 7.84 (br s, 96H), 7.67 (br d, J=6.8 Hz, 48H), 7.26 (br s, 24H), 5.85 (br s, 24H), 5.49 (br s, 24H), 4.39 (br s, 48H), 3.99 (br t, J=6.8 Hz, 48H), 3.81 (br s, 48H), 3.55 (br s, 48H), 3.48 3.44 (br m, 96H), 3.33 (br s, 96H), 1.70 (br s, 72H)

¹³C-NMR (125 MHz, DMSO-d₆, 27° C., δ ppm); 166.2 (C), 162.3 (C), 151.0 (CH), 136.1 (CH), 135.6 (C), 134.3 (C), 128.5 (CH), 125.6 (CH₂), 124.6 (CH), 115.2 (C), 93.9 (C), 89.8 (C), 74.0 (CH₂), 70.1 (CH₂), 69.8 (CH₂), 69.74 (CH₂), 69.67 (2CH₂), 68.1 (CH₂), 63.5 (CH₂), 17.8 (CH₃)

CSI-MS was carried out by charging CF₃SO₃Na into a solution of the complex (d) in DMSO, and then measuring after the counter anions had been converted into CF₃SO₃⁻.

CSI-MS (CF₃SO₃⁻ salt, CH₃CN); m/z; 2822.4 [M-6 (CF₃SO₃⁻)]⁶⁺, 2398.1 [M-7 (CF₃SO₃⁻)]⁷⁺, 2080.1 [M-8 (CF₃SO₃⁻)]⁸⁺, 1832.4 [M-9 (CF₃SO₃⁻)]⁹⁺, 1634.1 [M-10 (CF₃SO₃⁻]¹⁰⁺, 1471.9 [M-11 (CF₃SO₃⁻)]¹¹⁺, 1336.5 [M-12 (CF₃SO₃⁻)]¹²⁺, 1222.2 [M-13 (CF₃SO₃⁻)]¹³⁺

### Example 2

The complexes (a) to (d) obtained in Example 1 (0.583 μmol, 0.83 mM), 1 to 10 equivalents of 2,2′-azobisisobutyronitrile (AIBN) with respect to such complexes, and 0.7 mL of DMSO were placed in test tubes. A freeze-thawing operation was repeatedly carried out to remove oxygen present in the solutions, and then the test tubes were heated at 70° C. for 9 to 31 hours.

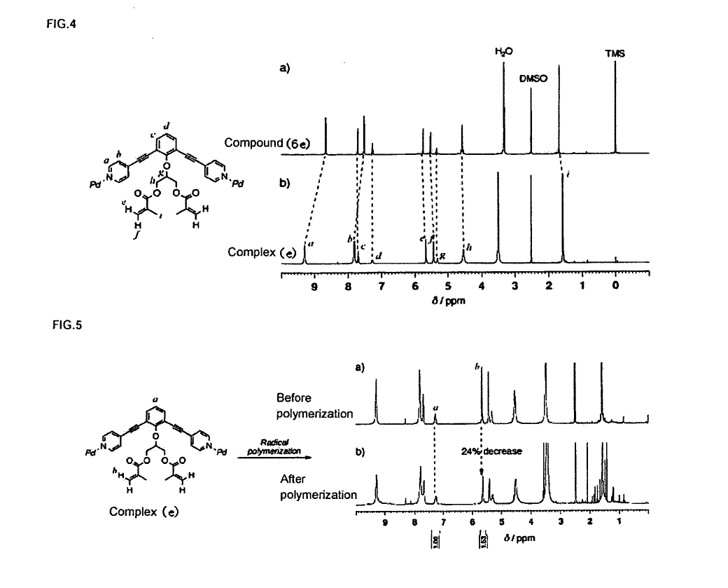

The polymerization conversion rates of the complexes (a), (b), (c), and (d) were 22%, 29%, 73%, and 62%, respectively. The polymerization conversion rates were quantified from the decrease in the integral value of the MMA units by NMR. FIG. 2 shows the ¹H-NMR spectra before and after polymerization for when the complex (c) was used. FIG. 3 shows a series of schematic structural models of the complexes (a) to (d) after polymerization.

### Example 3

Next, the complex (e), which is a bidentate organic ligand L having two polymerizable group moieties on its end, was produced as follows.

The production route is illustrated by the following reaction formulae.

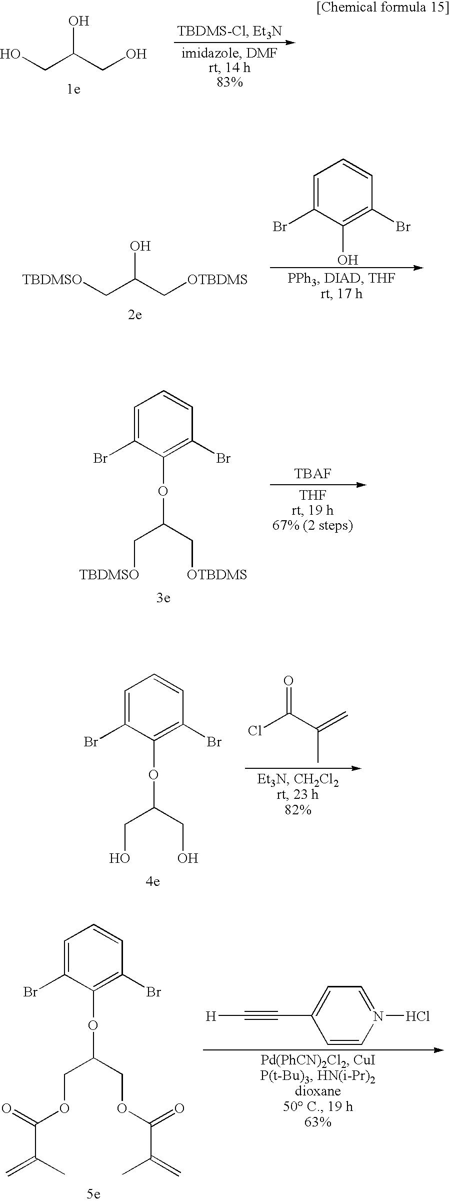

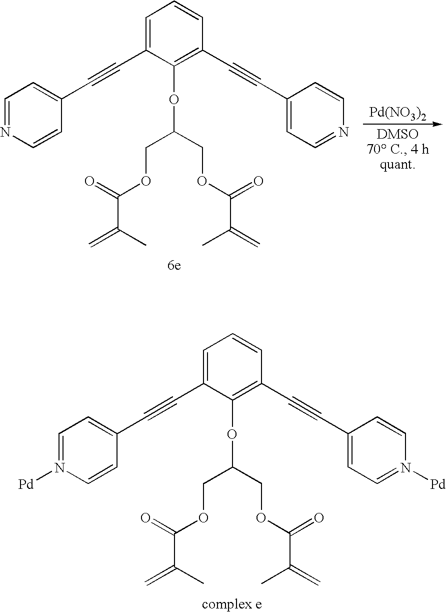

### (1) Synthesis of Compound (2e)

The compound (2e;

1,3-bis[(1,1-dimethyl)ethyldimethylsilyloxy]-2-propanol) was produced from glycerin (1e) according to the method described in C. J. O'Connor, K-A. Bang, C. M. Taylor, and M. A. Brimble, J. Mol. Catal. B: Enzym. 2001, 16, 147 to 157.

### (2) Synthesis of Compound (4e)

The compound (4e;

1,3-dibromo-2-r1,3-dihydroxyprop-2-yloxy]benzene) was produced as follows. First, 4.20 g (13.1 mmol) of the compound (2e), 3.04 (12.1 mmol) of 2,6-dibromophenol, and 3.89 g (14.8 mmol) of triphenylphosphine were dissolved in THF (100 mL). 2.8 mL (14.5 mmol) of diisopropylazodicarboxylate was added dropwise to this dissolved solution, and the resultant mixture was stirred for 17 hours at room temperature under an argon atmosphere. Then, the mixture was charged with 32 mL (32 mmol; 1.0 M in THF solution) of tetrabutylammonium fluoxide, and vigorously stirred for 19 hours at room temperature. The solvent was evaporated off, and the resultant residue was dissolved in chloroform (CHCl₃). This mixture was successively washed with water and saturated brine. The mixture was dried with anhydrous sodium sulfate, and then filtered. The filtrate was concentrated under reduced pressure, and the obtained concentrated product was purified by silica gel column chromatography (ethyl acetate/hexane=1/2 (v/v)) to give 2.64 g (8.10 mmol) of compound (4e) in the form of a white powder (yield 67%).

### (Physical Property Values)

¹H-NMR (500 Hz, CDCl₃, 27° C., δ ppm); 7.53 (d, J=8.1 Hz, 2H), 6.88 (t, J=8.1 Hz, 1H), 4.55 (quint, J=4.4 Hz, 1H), 4.05-3.95 (m, 4H), 2.47 (br s, 2H)

¹³C-NMR (125 MHz, CDCl₃, 27° C., δ ppm): 151.6 (C), 133.2 (CH), 126.3 (CH), 118.4 (C), 83.5 (CH), 62.0 (CH₂)

ESI-MS; m/z: 326.6 [M+H]⁺, 348.5 [M+Na]⁺

Anal. Calcd for C₉H₁₀Br₂O₃: C, 33.16; H, 3.09, Found: C, 33.07; H, 2.93

### (3) Synthesis of Compound (5e)

The compound (5e;

1,3-dibromo-2-r1,3-dimethacryloxyprop-2-yloxy]benzene) was produced as follows. First, 0.45 mL (4.6 mmol) of methacryloyl chloride was added dropwise under an argon atmosphere to a solution (12 mL) of 481.2 mg (1.48 mmol) of the compound (4e), 0.65 mL (4.7 mmol) of triethylamine, and 7.2 mg (58 μmol) of p-methoxyphenol (used as a radical inhibitor) in dry dichloromethane (dry CH₂Cl₂). The reaction mixture was stirred for 23 hours at room temperature. The reaction mixture was charged with water, and was then successively washed with water and saturated brine. The mixture was dried with anhydrous sodium sulfate, and then filtered. The filtrate was concentrated under reduced pressure, and the obtained concentrated product was purified by silica gel column chromatography (chloroform) to give 562 mg (1.22 mmol) of the compound (5e) in the form of a pale yellow oil (yield 82%).

### (Physical Property Values)

¹H-NMR (500 Hz, CDCl₃, 27° C., δ ppm); 7.51 (d, J=8.0 Hz, 2H), 6.85 (d, J=8.0 Hz, 1H), 6.00 (s, 2H), 5.55 (t, J=1.5 Hz, 1H), 5.03 (quint, J=6.0 Hz, 1H), 4.56 (dd, J=6.0 Hz, 2H), 4.51 (dd, J=6.0 Hz, 2H), 1.89 (s, 6H)

¹³C-NMR (125 MHz, CDCl₃, 27° C., δ ppm): 166.8 (C), 151.9 (C), 135.7 (C), 133.1 (CH), 126.3 (CH₂), 126.2 (CH), 118.3 (C), 78.2 (CH), 63.8 (CH₂), 18.2 (CH3)

ESI-MS; m/z: 484.5 [M+Na]⁺

### (4) Synthesis of Compound (6e)

The compound (6e;

2-r1,3-dimethacryloxyprop-2-yloxy]-1,3-bis(4-pyridylethnyl)benzene) was produced as follows. First, 0.30 mL (0.10 mmol; 10% hexane solution) of tri-t-butylphosphine and 1.2 mL (8.6 mmol) of diisopropylamine were charged into a solution of 367 mg (0.793 mmol) of the compound (5e), 327 mg (2.34 mmol) of 4-ethynylpyridine hydrochloride, 18.4 mg (0.0480 mmol) of Pd(PhCN)₂Cl₂, 7.0 mg (0.037 mmol) of copper(I) iodide (CuI), and 11.5 mg (0.0926 mmol) of p-methoxyphenol (used as a radical inhibitor) in 5 mL of deaerated dioxane.

The resultant mixture was stirred for 19 hours at 50° C. under an argon atmosphere. The reaction solution was charged with chloroform (15 mL), and then filtered. The filtrate was successively washed with aqueous ethylenediamine and saturated brine. The mixture was dried with anhydrous sodium sulfate, and then filtered. The filtrate was concentrated under reduced pressure, and the obtained concentrated product was purified by silica gel column chromatography (a gradient elution of chloroform from chloroform/methanol=100:1 (v/v)) to give the compound (5a) in the form of a yellow oil (yield 63%).

### (5) Synthesis of Complex (e)

The complex (e) was produced as follows. 7.37 mg (14.6 μmol) of the compound (6e) obtained by the above-described steps was charged into a solution of 1.68 mg (7.3 μmol) of Pd(NO₃)₂ in DMSO (0.8 mL), and the resultant mixture was stirred for 4 hours at 70° C. The structure of the complex (e) was confirmed by ¹H-NMR.

### (Physical Property Values)

¹H-NMR (500 Hz, DMSO-d₆, 27° C., δ ppm): 9.29 (br s, 96H), 7.81 (br s, 96H), 7.70 (br d, J=6.9 Hz, 48H), 7.26 (br t, J=6.9 Hz, 24H), 5.63 (br s, 48H), 5.44 (br s, 48H), 5.33 (br s, 24H), 4.54 (br s, 96H), 1.59 (br s, 144H)

FIG. 4 shows the ¹H-NMR spectra of the compound (6e) and the complex (e).

### Example 4

0.7 mL of DMSO containing 0.620 mmol (0.785 mM) of the complex (e) obtained in Example 3 and 8.3 equivalents of 2,2′-azobisisobutyronitrile (AIBN) with respect to such complex was placed in a test tube. A freeze-thawing operation was repeatedly carried out to remove oxygen present in the solution, and then the test tube was heated at 70° C. for 17 hours. The polymerization conversion rate quantified from the decrease in the integral value of the MMA units by NMR was 24%. FIG. 5 shows the ¹H-NMR spectra before and after polymerization.

### INDUSTRIAL APPLICABILITY

Production of the polymerizable spherical transition metal complex according to the present invention is very convenient, as such complex can be formed spontaneously. According to the present invention, a uniform particulate polymer can be obtained by introducing according to the intended purpose various polymerizable groups onto the inner surface of the polymerizable spherical transition metal complex, and polymerizing the polymerizable groups. Since the structure of the polymerizable spherical transition metal complex according to the present invention is clearly defined, the polymerization reaction can be carried out in a precisely-controlled, limited interior space.

1-16. (canceled)

17. A polymerizable spherical transition metal complex which is a spherical transition metal complex having a hollow shell, characterized in that the hollow shell is formed from a transition metal atoms (wherein a represents an integer of 6 to 60), and 2a bidentate organic ligands, the bidentate organic ligands have a substituent having at least one or more polymerizable group moieties at an end thereof, and the substituents are oriented towards an interior of the hollow shell.

18. A polymerizable spherical transition metal complex which is a spherical transition metal complex having a hollow shell, characterized in that the hollow shell is formed from b transition metal atoms (wherein b is 6, 12, 24, 30, or 60), and 2b bidentate organic ligands, the bidentate organic ligands have a substituent having at least one or more polymerizable group moieties at an end thereof, and the substituents are oriented towards an interior of the hollow shell.

19. The polymerizable spherical transition metal complex according to claim 17, represented by the formula MₐL₂ₐ (wherein a is an integer of 6 to 60, and each M and each L may respectively be the same or different) formed from a transition metal compound (M) and a bidentate organic ligand (L) having the substituent having the at least one or more polymerizable group moieties at the end thereof in a self-assembling manner so that the substituents are oriented towards the interior of the hollow shell.

20. The polymerizable spherical transition metal complex according to claim 18, represented by the formula M_{b}L_{2b} (wherein b is 6, 12, 24, 30, or 60, and each M and each L may respectively be the same or different) formed from a transition metal compound (M) and a bidentate organic ligand (L) having the substituent having the at least one or more polymerizable group moieties at the end thereof in a self-assembling manner so that the substituents are oriented towards the interior of the hollow shell.

21. The polymerizable spherical transition metal complex according to claim 17, wherein the polymerizable group moiety is a radical polymerizable group.

22. The polymerizable spherical transition metal complex according to claim 17, wherein the transition metal atom constituting the transition metal complex is one kind selected from the group consisting of Ti, Fe, Co, Ni, Cu, Zn, Ru, Rh, Pd, Cd, Os, Ir, and Pt.

23. The polymerizable spherical transition metal complex according to claim 17, wherein the bidentate organic ligand is a compound represented by the formula (I) 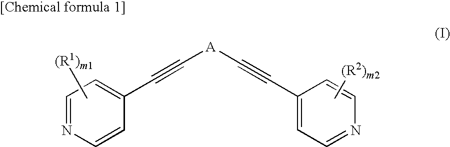
{wherein R¹ and R² each independently represent a halogen atom, an alkyl group which may be substituted, an alkoxyl group which may be substituted, a cyano group, or a nitro group;
m1 and m2 each independently represent an integer of 0 to 4, and when m1 and m2 are 2 or more, each R¹ and each R² may be the same or different;
A represents a group represented by the following formulae (a-1) to (a-4), 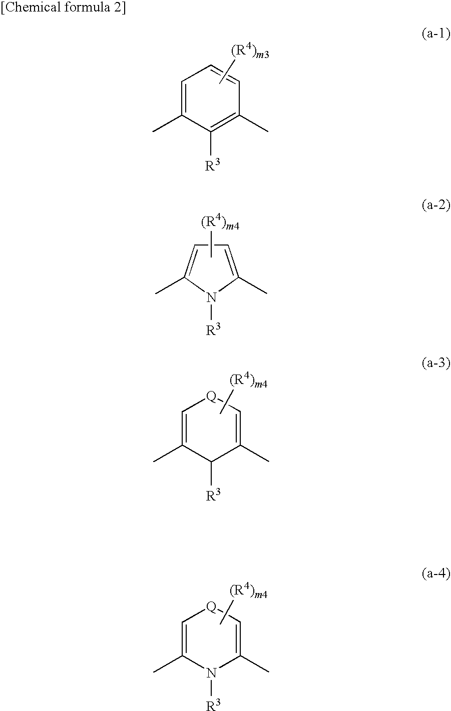
[wherein R³ represents a group having a polymerizable functional group on an end thereof;
R⁴ represents a halogen atom, an alkyl group which may be substituted, an alkoxyl group which may be substituted, a cyano group, or a nitro group;
m3 represents an integer of 0 to 3, m4 represents an integer of 0 to 2, and when m3 is 2 or more and m4 is 2, plural R^{4s} may be the same or different; and
Q represents -Nr1- (wherein r1 represents a hydrogen atom, an alkyl group, an aryl group, or an acyl group), —O—, —C(═O)—, —S—, or —SO₂—]}.

24. The polymerizable spherical transition metal complex according to claim 23, wherein R³ is a group represented by the formula -D-E [wherein D represents a linking group represented by the formula —(O—CH₂)s- (wherein s represents an integer of 0 to 20), a linking group represented by the formula —(CH₂)t- (wherein t represents an integer of 0 to 20), or a linking group formed by a combination thereof; and E represents a polymerizable group].

25. The polymerizable spherical transition metal complex according to claim 23, wherein R³ has a linking group which has 2 or 3 branches represented by -D1- [wherein D1 is represented by the formula —O—C—, or —O—CH—], and has on each of 2 or 3 branch chains of this linking group a group represented by -D-E [wherein D represents a linking group represented by the formula —(O—CH₂)s- (wherein s represents an integer of 0 to 20), a linking group represented by the formula —(CH₂)t- (wherein t represents an integer of 0 to 20), or a linking group formed by a combination thereof; and E represents a polymerizable group].

26. The polymerizable spherical transition metal complex according to claim 24, wherein s and t of the linking group represented by the formulae —(O—CH₂)s- and —(CH₂)t- are 3, and if the linking group is formed from a combination of these, the sum of s and t is 3.

27. The polymerizable spherical transition metal complex according to claim 24, wherein E is a group represented by the formula —O—CO—C(r2)=CH₂ (wherein r2 represents a hydrogen atom or a methyl group).

28. The polymerizable spherical transition metal complex according to claim 17, wherein the bidentate organic ligand is a compound represented by the formula (I-1), 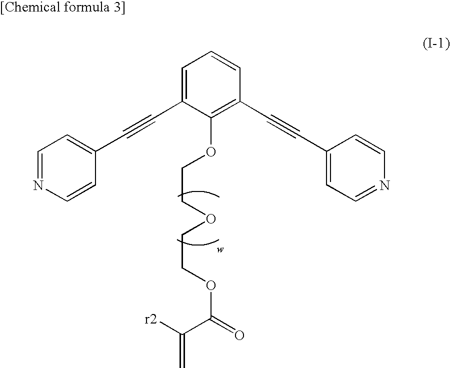
(wherein r2 represents a hydrogen atom or a methyl group; and w represents an integer of 0 to 20).

29. The polymerizable spherical transition metal complex according to claim 17, wherein the bidentate organic ligand is a compound represented by the formula (I-1′), 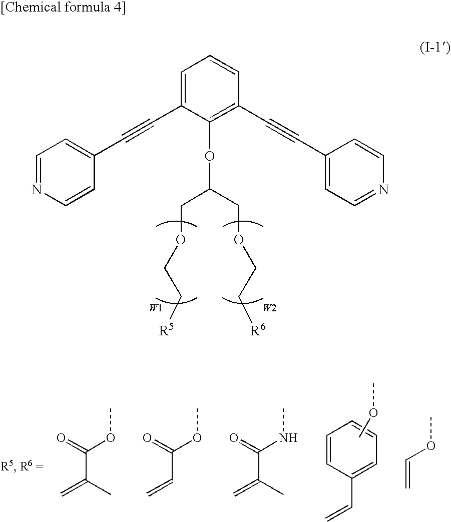
(wherein R⁵ and R⁶ represent a polymerizable group represented by a methacryloxyl group, an acryloxyl group, a methacrylamide group, a vinylphenoxy group, and a vinyloxy group; w1 and w2 represent an integer of 0 to 20; R⁵ and R⁶ may be the same or different; and w1 and w2 may be the same or different).

30. A method for producing the polymerizable spherical transition metal complex according to claim 17, characterized by reacting a transition metal compound (M) and a bidentate organic ligand (L) having a substituent having at least one or more polymerizable group moieties at an end thereof, in a proportion of 1 to 5 moles of the bidentate organic ligand (L) with respect to 1 mole of the transition metal compound (M).

31. A spherical transition metal complex obtained by polymerizing the polymerizable spherical transition metal complex according to claim 17, in which the polymerizable groups are polymerized in the hollow shell to form a polymer.

32. A method for producing the spherical transition metal complex according to claim 31, characterized by adding a polymerization initiator to a solvent solution containing a polymerizable spherical transition metal complex to polymerize the polymerizable groups, wherein the polymerizable spherical transition metal complex is a spherical transition metal complex having a hollow shell, characterized in that the hollow shell is formed from a transition metal atoms (wherein a represents an integer of 6 to 60), and 2a bidentate organic ligands, the bidentate organic ligands have a substituent having at least one or more polymerizable group moieties at an end thereof, and the substituents are oriented towards an interior of the hollow shell.
